(19) United States
(12) Patent Application Publication
(10) Pub. No.: US 2022/0234618 A1
(43) Pub. Date: Jul. 28, 2022

(54) HOMOTOPIC-BASED PLANNER FOR AUTONOMOUS VEHICLES

(71) Applicant: Motional AD LLC, Boston, MA (US)

(72) Inventors: Juraj Kabzan, Singapore (SG); Emilio Frazzoli, Newton, MA (US)

(21) Appl. No.: 17/544,556

(22) Filed: Dec. 7, 2021

Related U.S. Application Data
(60) Provisional application No. 63/142,878, filed on Jan. 28, 2021.

(51) Int. Cl. B60W 60/00; B60W 40/06; B60W 50/00; B60W 30/095; B60W 30/09; B60W 30/14

(52) U.S. Cl. CPC B60W 60/0015; B60W 40/06; B60W 50/0097; B60W 2554/4029; B60W 30/0953; B60W 30/09; B60W 30/143; B60W 30/0956

(57) ABSTRACT

Among other things, techniques are described for planning a route for an autonomous vehicle. As an example, a set of candidate constraints for a road segment to be traversed by a vehicle is obtained. A plurality of homotopies are determined, each including a different respective combination of the candidate constraints. For each homotopy, a first prediction of a motion of the vehicle is generated according to a first degree of precision, and a determination is made that the vehicle can traverse the road segment according to a subset of the homotopies. Further, a plurality of trajectories are determined according to the subset of the homotopies, including generating at least one second prediction of the motion of the vehicle according to a second degree of precision greater than the first degree of precision, and selecting one of the trajectories.

### RELATED APPLICATION

This application claims the benefit of U.S. Provisional Application Ser. No. 63/142,878, filed Jan. 28, 2021, the entire contents of which are incorporated herein by reference.

### FIELD OF THE INVENTION

This description relates to route planning for autonomous vehicles.

### BACKGROUND

A software stack of an autonomous vehicle (AV) can implement a planning module that generates multiple candidate trajectories along which the AV can traverse through an environment (e.g., through a 4-way intersection). The trajectories can be generated based on a map, a current physical state of the AV (e.g., the current position, velocity, heading, etc.) and one or more object detected by the AV.

### BRIEF DESCRIPTION OF THE DRAWINGS

FIG. 1 shows an example of an AV having autonomous capability.

FIG. 2 shows an example “cloud” computing environment.

FIG. 3 shows a computer system.

FIG. 4A shows an example architecture for an AV.

FIG. 4B shows an example planning module.

FIG. 5 shows an example of inputs and outputs that can be used by a perception module.

FIG. 6 shows an example of a LiDAR system.

FIG. 7 shows the LiDAR system in operation.

FIG. 8 shows the operation of the LiDAR system in additional detail.

FIG. 9 shows a block diagram of the relationships between inputs and outputs of a planning module.

FIG. 10 shows a directed graph used in path planning.

FIG. 11 shows a block diagram of the inputs and outputs of a control module.

FIG. 12 shows a block diagram of the inputs, outputs, and components of a controller.

FIG. 13 illustrates an example process for generating trajectories using a homotopic-based approach.

FIG. 14 shows an example decision graph.

FIGS. 15A-15F shows a practical example of assessing the feasibility of homotopies using a decision graph.

FIG. 16 shows a flow diagram of an example process for controlling an operation of an AV.

### DETAILED DESCRIPTION

In the following description, for the purposes of explanation, numerous specific details are set forth in order to provide a thorough understanding of the present invention. It will be apparent, however, that the present invention can be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:

1. General Overview

2. System Overview

3. AV Architecture

4. AV Inputs

5. AV Planning

6. AV Control

7. Homotopic-Based Planner

### General Overview

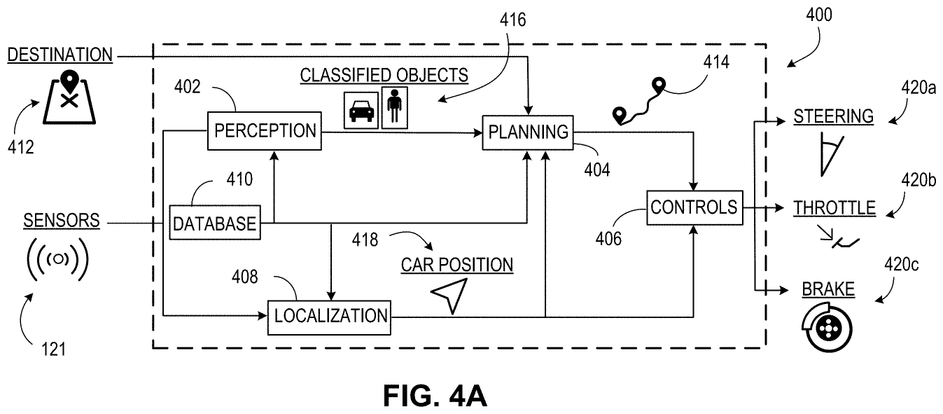

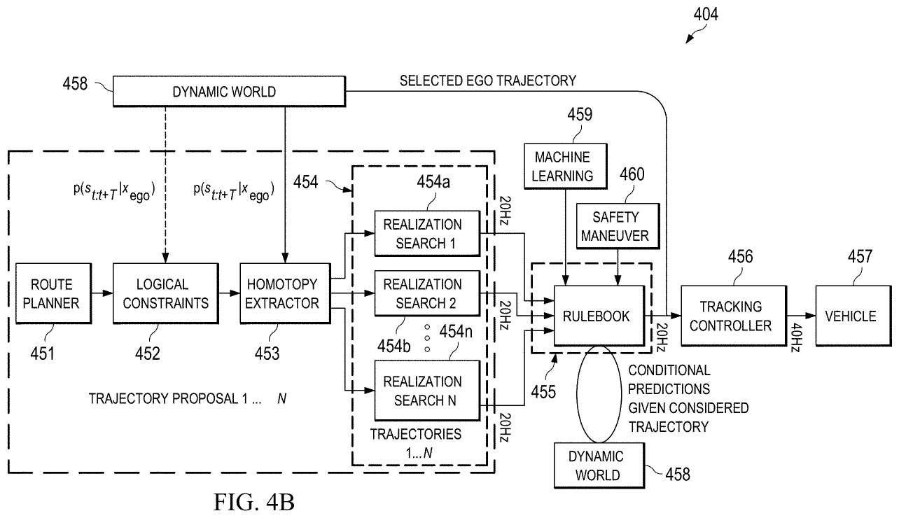

The disclosed embodiments of an AV planning module determine one or more trajectories for an AV using a “homotopic”-based planning approach. As an example, a planning module (e.g., planning module 404 shown in FIGS. 4A and 4B) can determine a route for an AV, and determine several candidate constraints for traversing one or more road segments of the route. Further, the planning module can determine feasible homotopies of those constraints (e.g., combinations of constraints that the AV can feasibly adhere to while traversing the one or more road segments), generate trajectories for each of the feasible homotopies, and select one of the trajectories for execution by the AV. In some implementations, the techniques described herein can be performed with respect to a subset of the road segments that make up a route. In some implementations, the techniques described herein can be performed with respect to all of the road segments that make up a route.

Some of the advantages of these techniques include reducing the computational resources needed to determine a trajectory for an AV. For example, in some implantations, a planning module can determine a trajectory in a brute force manner by (i) generating a large number of candidate trajectories (e.g., to account for every possible trajectory that the AV might take along the route), (ii) evaluating each of the candidate trajectories, and (iii) selecting a particular candidate trajectory for execution. However, it can be computationally expensive to generate and evaluate trajectories across such a large search space (e.g., a search space that includes every possible trajectory). To reduce the search space, a planning module can identify a subset of the search space corresponding to the feasible homotopies (e.g., combinations of constraints that the AV is capable of adhering to safely while traversing the route), and generate candidate trajectories only for that subset. Accordingly, the search space can be reduced considerably.

### System Overview

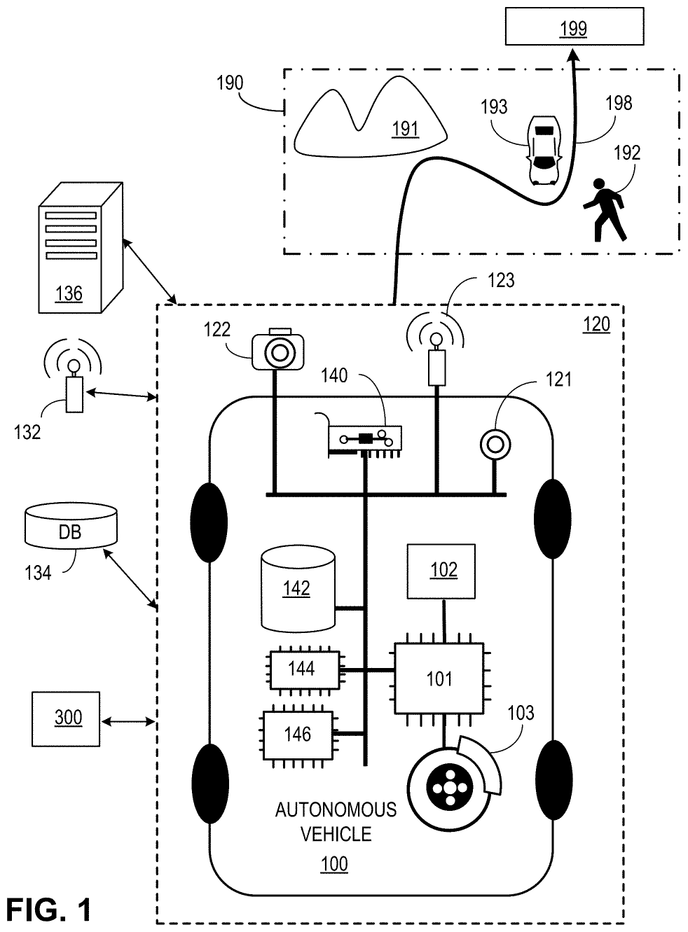

FIG. 1 shows an example of an AV 100 having autonomous capability.

As used herein, the term “autonomous capability” refers to a function, feature, or facility that enables a vehicle to be partially or fully operated without real-time human intervention, including without limitation fully AVs, highly AVs, and conditionally AVs.

As used herein, an AV (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to navigate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In an embodiment, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle. A lane is sometimes identified based on lane markings. For example, a lane may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings, or having two lanes between the lane markings. A lane could also be interpreted in the absence of lane markings. For example, a lane may be defined based on physical features of an environment, e.g., rocks and trees along a thoroughfare in a rural area or, e.g., natural obstructions to be avoided in an undeveloped area. A lane could also be interpreted independent of lane markings or physical features. For example, a lane could be interpreted based on an arbitrary path free of obstructions in an area that otherwise lacks features that would be interpreted as lane boundaries. In an example scenario, an AV could interpret a lane through an obstruction-free portion of a field or empty lot. In another example scenario, an AV could interpret a lane through a wide (e.g., wide enough for two or more lanes) road that does not have lane markings. In this scenario, the AV could communicate information about the lane to other AVs so that the other AVs can use the same lane information to coordinate path planning among themselves.

As used herein, “homotopy” means a subset of a set of constraints on a trajectory of an AV that the AV can adhere to while traversing a particular route.

As used herein, “feasible” means whether an AV can adhere to a constraint in a homotopy while traveling to a destination.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

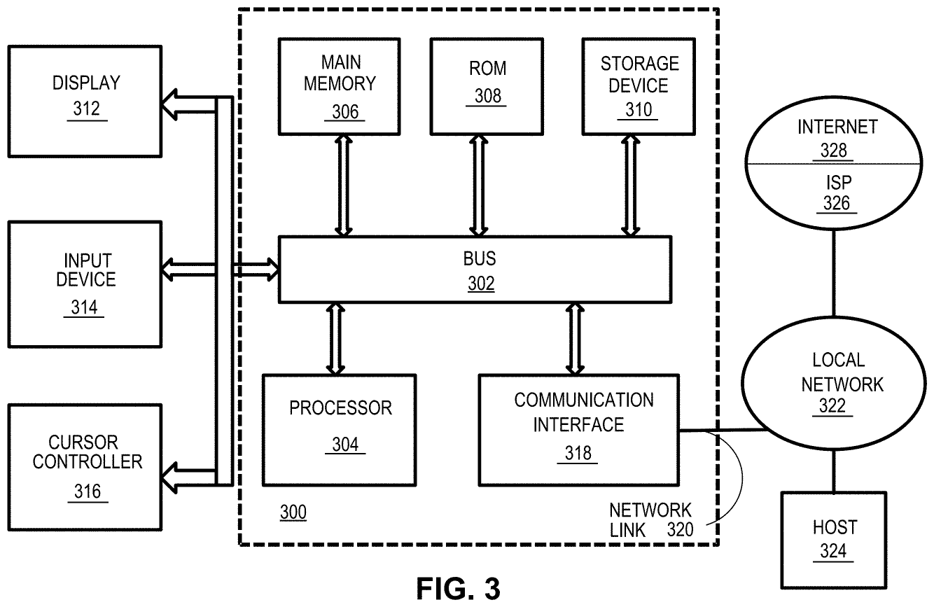

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment similar to cloud computing environment 300 described below with respect to FIG. 3.

In general, this document describes technologies applicable to any vehicles that have one or more autonomous capabilities including fully AVs, highly AVs, and conditionally AVs, such as so-called Level 5, Level 4 and Level 3 vehicles, respectively (see SAE International's standard J3016: Taxonomy and Definitions for Terms Related to On-Road Motor Vehicle Automated Driving Systems for more details on the classification of levels of autonomy in vehicles). The technologies described in this document are also applicable to partially AVs and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, one or more of the Level 1, 2, 3, 4 and 5 vehicle systems can automate certain vehicle operations (e.g., steering, braking, and using maps) under certain operating conditions based on processing of sensor inputs. The technologies described in this document can benefit vehicles in any levels, ranging from fully AVs to human-operated vehicles.

AVs have advantages over vehicles that require a human driver. One advantage is safety. For example, in 2016, the United States experienced 6 million automobile accidents, 2.4 million injuries, 40,000 fatalities, and 13 million vehicles in crashes, estimated at a societal cost of $910+ billion. U.S. traffic fatalities per 100 million miles traveled have been reduced from about six to about one from 1965 to 2015, in part due to additional safety measures deployed in vehicles. For example, an additional half second of warning that a crash is about to occur is believed to mitigate 60% of front-to-rear crashes. However, passive safety features (e.g., seat belts, airbags) have likely reached their limit in improving this number. Thus, active safety measures, such as automated control of a vehicle, are the likely next step in improving these statistics. Because human drivers are believed to be responsible for a critical pre-crash event in 95% of crashes, automated driving systems are likely to achieve better safety outcomes, e.g., by reliably recognizing and avoiding critical situations better than humans; making better decisions, obeying traffic laws, and predicting future events better than humans; and reliably controlling a vehicle better than a human.

Referring to FIG. 1, an AV system 120 operates the AV 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

In an embodiment, the AV system 120 includes devices 101 that are instrumented to receive and act on operational commands from the computer processors 146. We use the term “operational command” to mean an executable instruction (or set of instructions) that causes a vehicle to perform an action (e.g., a driving maneuver). Operational commands can, without limitation, including instructions for a vehicle to start moving forward, stop moving forward, start moving backward, stop moving backward, accelerate, decelerate, perform a left turn, and perform a right turn. In an embodiment, computing processors 146 are similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the AV 100, such as the AV's position, linear and angular velocity and acceleration, and heading (e.g., an orientation of the leading end of AV 100). Example of sensors 121 are GPS, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 308 or storage device 310 described below in relation to FIG. 3. In an embodiment, memory 144 is similar to the main memory 306 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the AV 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the AV 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among AVs.

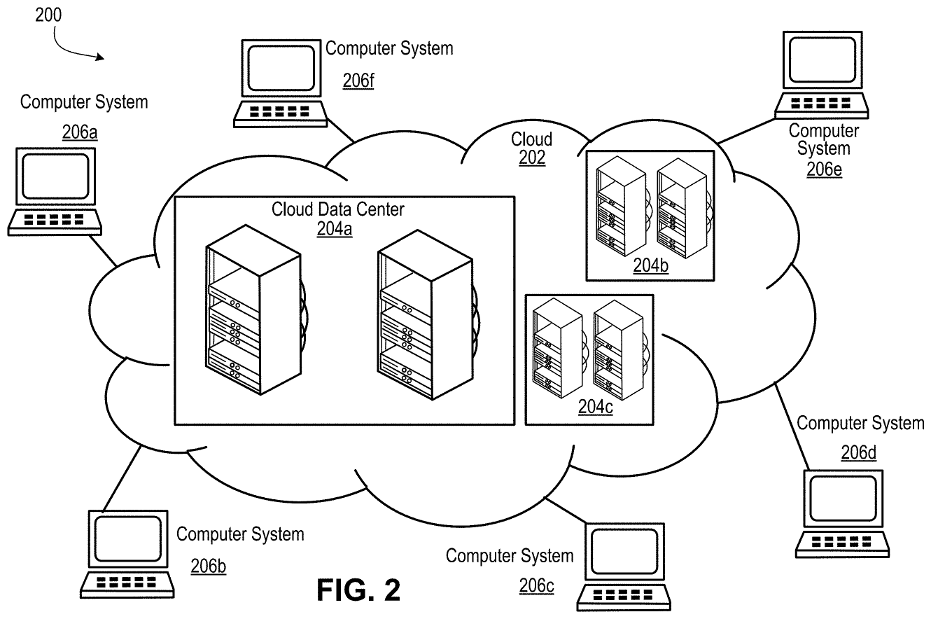

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment 200 as described in FIG. 2. The communication interfaces 140 transmit data collected from sensors 121 or other data related to the operation of AV 100 to the remotely located database 134. In an embodiment, communication interfaces 140 transmit information that relates to teleoperations to the AV 100. In some embodiments, the AV 100 communicates with other remote (e.g., “cloud”) servers 136.

In an embodiment, the remotely located database 134 also stores and transmits digital data (e.g., storing data such as road and street locations). Such data is stored on the memory 144 on the AV 100, or transmitted to the AV 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data can be stored on the memory 144 on the AV 100, or transmitted to the AV 100 via a communications channel from the remotely located database 134.

Computing devices 146 located on the AV 100 algorithmically generate control actions based on both real-time sensor data and prior information, allowing the AV system 120 to execute its autonomous driving capabilities.

In an embodiment, the AV system 120 includes computer peripherals 132 coupled to computing devices 146 for providing information and alerts to, and receiving input from, a user (e.g., an occupant or a remote user) of the AV 100. In an embodiment, peripherals 132 are similar to the display 312, input device 314, and cursor controller 316 discussed below in reference to FIG. 3. The coupling is wireless or wired. Any two or more of the interface devices can be integrated into a single device.

In an embodiment, the AV system 120 receives and enforces a privacy level of a passenger, e.g., specified by the passenger or stored in a profile associated with the passenger. The privacy level of the passenger determines how particular information associated with the passenger (e.g., passenger comfort data, biometric data, etc.) is permitted to be used, stored in the passenger profile, and/or stored on the cloud server 136 and associated with the passenger profile. In an embodiment, the privacy level specifies particular information associated with a passenger that is deleted once the ride is completed. In an embodiment, the privacy level specifies particular information associated with a passenger and identifies one or more entities that are authorized to access the information. Examples of specified entities that are authorized to access information can include other AVs, third party AV systems, or any entity that could potentially access the information.

A privacy level of a passenger can be specified at one or more levels of granularity. In an embodiment, a privacy level identifies specific information to be stored or shared. In an embodiment, the privacy level applies to all the information associated with the passenger such that the passenger can specify that none of her personal information is stored or shared. Specification of the entities that are permitted to access particular information can also be specified at various levels of granularity. Various sets of entities that are permitted to access particular information can include, for example, other AVs, cloud servers 136, specific third party AV systems, etc.

In an embodiment, the AV system 120 or the cloud server 136 determines if certain information associated with a passenger can be accessed by the AV 100 or another entity. For example, a third-party AV system that attempts to access passenger input related to a particular spatiotemporal location must obtain authorization, e.g., from the AV system 120 or the cloud server 136, to access the information associated with the passenger. For example, the AV system 120 uses the passenger's specified privacy level to determine whether the passenger input related to the spatiotemporal location can be presented to the third-party AV system, the AV 100, or to another AV. This enables the passenger's privacy level to specify which other entities are allowed to receive data about the passenger's actions or other data associated with the passenger.

FIG. 2 illustrates an example “cloud” computing environment. Cloud computing is a model of service delivery for enabling convenient, on-demand network access to a shared pool of configurable computing resources (e.g., networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In an embodiment, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In an embodiment, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

The computing systems 206a-f or cloud computing services consumers are connected to the cloud 202 through network links and network adapters. In an embodiment, the computing systems 206a-f are implemented as various computing devices, for example servers, desktops, laptops, tablet, smartphones, Internet of Things (IoT) devices, AVs (including, cars, drones, shuttles, trains, buses, etc.) and consumer electronics. In an embodiment, the computing systems 206a-f are implemented in or as a part of other systems.

FIG. 3 illustrates a computer system 300. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques, or can include one or more general purpose hardware processors programmed to perform the techniques pursuant to program instructions in firmware, memory, other storage, or a combination. Such special-purpose computing devices can also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 300 includes a bus 302 or other communication mechanism for communicating information, and a hardware processor 304 coupled with a bus 302 for processing information. The hardware processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In an embodiment, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In an embodiment, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but can be used in conjunction with transmission media. Transmission media participates in transferring information between storage media. For example, transmission media includes coaxial cables, copper wire and fiber optics, including the wires that comprise the bus 302. Transmission media can also take the form of acoustic or light waves, such as those generated during radio-wave and infrared data communications.

In an embodiment, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 can optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic or optical signals that carry digital data streams. The signals through the various networks and the signals on the network link 320 and through the communication interface 318, which carry the digital data to and from the computer system 300, are example forms of transmission media. In an embodiment, the network 320 contains the cloud 202 or a part of the cloud 202 described above.

The computer system 300 sends messages and receives data, including program code, through the network(s), the network link 320, and the communication interface 318. In an embodiment, the computer system 300 receives code for processing. The received code is executed by the processor 304 as it is received, and/or stored in storage device 310, or other non-volatile storage for later execution.

### AV Architecture

FIG. 4A shows an example architecture 400 for an AV (e.g., the AV 100 shown in FIG. 1). The architecture 400 includes a perception module 402 (sometimes referred to as a perception circuit), a planning module 404 (sometimes referred to as a planning circuit), a control module 406 (sometimes referred to as a control circuit), a localization module 408 (sometimes referred to as a localization circuit), and a database module 410 (sometimes referred to as a database circuit). Each module plays a role in the operation of the AV 100. Together, the modules 402, 404, 406, 408, and 410 can be part of the AV system 120 shown in FIG. 1. In some embodiments, any of the modules 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things). Each of the modules 402, 404, 406, 408, and 410 is sometimes referred to as a processing circuit (e.g., computer hardware, computer software, or a combination of the two). A combination of any or all of the modules 402, 404, 406, 408, and 410 is also an example of a processing circuit.

In use, the planning module 404 receives data representing a destination 412 and determines data representing a trajectory 414 (sometimes referred to as a route) that can be traveled by the AV 100 to reach (e.g., arrive at) the destination 412. In order for the planning module 404 to determine the data representing the trajectory 414, the planning module 404 receives data from the perception module 402, the localization module 408, and the database module 410.

The perception module 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning module 404.

The planning module 404 also receives data representing the AV position 418 from the localization module 408. The localization module 408 determines the AV position by using data from the sensors 121 and data from the database module 410 (e.g., a geographic data) to calculate a position. For example, the localization module 408 uses data from a GNSS (Global Navigation Satellite System) sensor and geographic data to calculate a longitude and latitude of the AV. In an embodiment, data used by the localization module 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types. In an embodiment, the high-precision maps are constructed by adding data through automatic or manual annotation to low-precision maps.

The control module 406 receives the data representing the trajectory 414 and the data representing the AV position 418 and operates the control functions 420a-c (e.g., steering, throttling, braking, ignition system) of the AV in a manner that will cause the AV 100 to travel the trajectory 414 to the destination 412. For example, if the trajectory 414 includes a left turn, the control module 406 will operate the control functions 420a-c in a manner such that the steering angle of the steering function will cause the AV 100 to turn left and the throttling and braking will cause the AV 100 to pause and wait for passing pedestrians or vehicles before the turn is made.

FIG. 4B is a block diagram of the planning module 404, in accordance with one or more embodiments. The planning module 404 includes route planner 451, logical constraints 452, homotopy extractor 453, sample-based maneuver realizer 454, trajectory score generator 455, tracking controller 456 and AV 457.

In an embodiment, the route planner 451: 1) receives an initial and terminal state; 2) plans a desired sequence of roadblocks/lanes with a lane router; 3) splits the route into segments based on a lane change, such that a segment does not contain a lane change; 4) selects segments in which the AV is located based on the AV's state (from dynamic world model 458) which is projected on the road blocks; 5) extracts baseline paths for selected segments (which can be marked as baseline path “desired” in case a lane change is desired); and 6) trims baseline paths based on maximal/minimal length. In case there is no lane change required, the adjacent baseline path is extracted and labeled only as “optional,” meaning the AV can use the lane if needed for collision avoidance.

In an embodiment, route planner 451 generates a graphical representation of the operating environment of the AV, the AV's physical state based on sensor data (e.g., speed, position), and possible outcomes. In an embodiment, the graphical representation is a directed graph or decision graph (described below) that includes a number of nodes where each node represents a sample of the AV's decision space for a particular driving scenario, such as, for example, a plurality of maneuvers related to other vehicles and objects and environmental constraints (e.g., drivable area, lane markings). The edges of the directed graph represent different trajectories available to the AV for the particular driving scenario.

In an embodiment, logical constraints 452 include “hard” constraints and “soft” constraints. Hard constraints are logical constraints that must not be violated because, if violated, the AV would collide with another object, such as a pedestrian who may be “jaywalking” across the road. Note that hard constraints do not imply “do not collide.” Rather, a hard constraint can be, for example, a combination of spatial and speed constraints that can lead to a collision. For example, a hard constraint can be expressed in words as: “if the AV proceeds at 30 mph in lane A or accelerates at 2 mph/s in lane B, it will collide with the pedestrian.” Hence, the hard constraint expressed formally is “do not proceed at 30 mph in lane A” and “do not exceed 25 mph in lane A.”

Soft constraints are constraints that should be followed by the AV but can be violated to, for example, complete a trip to a destination or to avoid a collision. Some examples of “soft” constraints include but are not limited to: passenger comfort constraints and a minimum threshold of lateral clearance from a pedestrian who is crossing the street (jaywalking) to provide comfort to the pedestrian and the AV passenger. In an embodiment, soft constraints are embodied in the one or more rulebook(s). Soft constraints can include spatial constraints that change over time. A spatial constraint can be a drivable area.

In some embodiments, different constraints are sampled differently. For example, homotopy extractor 453 can operate at 10 Hz and the realization searches can be are performed twice as fast at 20 Hz.

In an embodiment, homotopy extractor 453 generates a set of potential maneuvers for the AV. Instead of hypothesizing objectives and then choosing the objective that performs the best, homotopy extractor 453 hypothesizes active constraint sets, referred to as a “homotopy” (defined below), and then chooses the constraint sets that result in lower cost. From route planner 451, homotopy extractor 453 receives a route plan which contains the baseline path. The baseline path is the best estimate of the lane that the AV is located in, and an optional path (a potentially desired path) which can be used by the AV when performing a lane change. In an embodiment, the route planner 451 also contains speed squared and spatial constraints which are computed along the baseline path (e.g., computed with a bound generator). In some implementations, the route plan can contain multiple baseline paths that can be traversed by the AV. One of the baseline paths can be designated as an “anchor path.” By default, the AV can traverse the anchor path if the anchor path is not obstructed (e.g., by other vehicles, pedestrians, barriers, etc.). The AV can traverse one of the other baseline paths if the anchor path is obstructed.

Given an initial state of the AV, a terminal state of the AV, a map representation and predictions of other agents in the scene, the homotopy extractor 453 finds all “approximately” feasible maneuvers the AV can perform. Note that in this context the resulting maneuvers might not be dynamically feasible but the homotopy extractor 453 guarantees that the resulting constraint set describing the maneuver is not an empty set (considering also the AV footprint). An AV maneuver is described by the homotopy. As described above, a homotopy is a subset of a set of constraints on a trajectory of an AV that the AV can adhere to while traversing a particular route. In some implementations, a homotopy can be a unique space where any path starting at a starting position (AV state) and ending at a terminal state can be continuously deformed. To find these maneuvers, the homotopy extractor 453 iterates over all possible decisions the AV can take with respect to other agents, e.g., pass on the left/right side, pass before or after or just stay behind. In short, an output of the homotopy extractor 453 describes the spatio-temporal location of the AV to an agent. Although this can be a computationally expensive search, due to a set of simple checks all infeasible combinations can be eliminated.

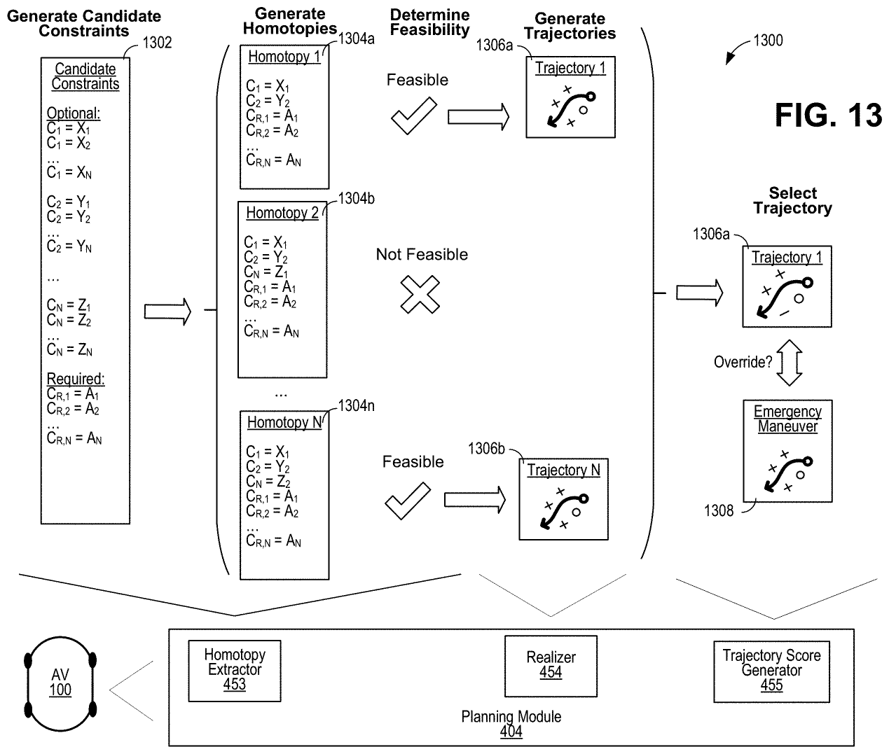

To be able to describe constraints representing where the other agents are located, and what a collision of the AV with these agents mean, every agent is converted into a station-based and spatial-based obstacle. The station-based constraint is parameterized over time while the spatial-based constraint is parameterized over both station and time. Further detail regarding the homotopy extractor 453 is described in reference to FIGS. 13-16.

In an embodiment, the realization searches 454a . . . 454n are performed by sample-based maneuver realizer 454 to generate a set of trajectories 1 . . . N for all the extracted homotopies. The sample-based maneuver realizer 454 is described in further detail in co-pending application, Attorney Docket No. 46154-0310001, entitled “Sampling-Based Maneuver Realizer,” filed Dec. 7, 2021, which is incorporated by reference herein in its entirety. Example techniques for generating maneuvers and/or trajectories are also described in further detail in co-pending application, Attorney Docket No. 46154-0316001, entitled “Vehicle Operation Using Maneuver Generation,” filed Dec. 7, 2021, which is incorporated by reference herein in its entirety.

In an embodiment, trajectory score generator 455 uses one or more rulebooks, one or more machine learning models 459 and/or one or more safety maneuver models 460 to score the trajectories 1 . . . N, and uses the scores to select the trajectory that is the most compliant with the rules in the one or more rulebooks. In an embodiment, a predefined cost function is used to generate the trajectory scores.

In embodiments that use a cost function, a total order or partial order hierarchical cost function can be used to score the trajectories. The cost function is applied to metrics (e.g., Boolean values) associated with the violation and/or satisfaction of a hierarchy of rules in one or more rulebooks based on priority or relative importance. An example hierarchy of rules based on priority is as follows (from top to bottom): collision avoidance (Boolean), blockage (Boolean), terminal state in desired lane (Boolean), lane change (Boolean) and comfort (double float). In this example, every non-zero priority rule is defined as Boolean to avoid over-optimization of high priority costs. The most important or highest priority rule is to avoid collision, followed by avoiding blockage, followed by avoiding a terminal state in a desired lane, followed by a lane change, followed by comfort rules (e.g., maximum accelerations or decelerations). These example rules are described more fully as follows:
Collision: Is set to TRUE if there exists a state along the scored trajectory where the AV vehicle's footprint collides with the footprint of any other agent/object (e.g., they are considered to collide if their polygons intersect).
Blockage: A trajectory is considered blocked if the terminal homotopy does not contain the desired goal state and the terminal velocity of the trajectory is below a specified threshold (e.g., 2 m/s). A goal state can be, for example, a particular position of the AV (e.g., expressed according to a coordinate system, such as a (x,y) position).
Terminal State in Desired Lane: Is set to TRUE if the terminal state of a trajectory is found in a lane which is desired lane change, and is set to TRUE if the AV's footprint crosses a lane divider at any time during the trajectory.
Comfort: maximums for acceleration/deceleration, braking distance, lateral clearance can be considered.

For each trajectory, the rules are checked and metrics determined. A cost function is formulated using the metrics and then minimized using, for example, a least squares formulation or any other suitable solver. The trajectory with the lowest cost is the selected trajectory, i.e., the trajectory with the least rule violations or most compliant. In an embodiment the minimized cost functions can be used to score the trajectories, as described in further detail below. Note that the rules described above are merely examples. Those with ordinary skill will recognized that any suitable cost function and rulebook can be used for trajectory scoring, including rulebooks with more or fewer rules.

For machining learning embodiments, trajectory score generator 455 can implement one or more machine learning models 459 and/or safety maneuver models 460 to score trajectories. For example, a neural network can be used to predict a score of trajectory.

Tracking controller 456 is used to improve the robustness of the planning module 404 against unexpected spikes in computational demand. Tracking controller 456 is a fast-executing tracking controller that provides steady and smooth control inputs and allows the planning module 404 to react faster towards disturbances. In an embodiment, tracking controller 456 runs at 40 Hz. The input to tracking controller 456 is the selected trajectory provided by the trajectory score generator 455 that has been parameterized by time, such that tracking controller 456 can query an exact desired position of the AV at a given time.

In an embodiment, the tracking controller 456 is formulated as a type of model predictive control (MPC) problem with constraints on the control inputs and states. However, any suitable multivariable control algorithm can also be used. The MPC-type formulation uses an internal dynamic model of a process, a cost function J over a receding horizon and an optimization algorithm for minimizing the cost function J using a control input u. An example cost function for optimization is a quadratic cost function.

In an embodiment, the dynamic model is a kinematic vehicle model in Cartesian coordinates or any other suitable reference coordinate frame. For example, the kinematic vehicle model can be a bicycle model that allows a side slip angle to be defined geometrically to express yaw rate in terms of variables that are represented with respect to the center of gravity of the AV. In an embodiment, the cost function J follows a contouring error formulation (orthogonal deviation from the anchor path) where the objective is to minimize the lateral and longitudinal error.

### AV Inputs

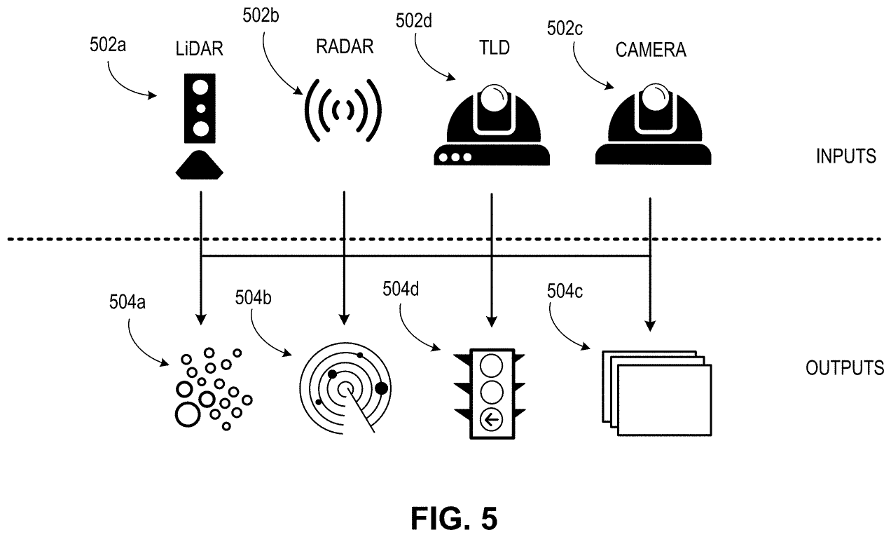

FIG. 5 shows an example of inputs 502a-d (e.g., sensors 121 shown in FIG. 1) and outputs 504a-d (e.g., sensor data) that is used by the perception module 402 (FIG. 4A). One input 502a is a LiDAR (Light Detection and Ranging) system (e.g., LiDAR 123 shown in FIG. 1). LiDAR is a technology that uses light (e.g., bursts of light such as infrared light) to obtain data about physical objects in its line of sight. A LiDAR system produces LiDAR data as output 504a. For example, LiDAR data is collections of 3D or 2D points (also known as a point clouds) that are used to construct a representation of the environment 190.

Another input 502b is a RADAR system. RADAR is a technology that uses radio waves to obtain data about nearby physical objects. RADARs can obtain data about objects not within the line of sight of a LiDAR system. A RADAR system produces RADAR data as output 504b. For example, RADAR data are one or more radio frequency electromagnetic signals that are used to construct a representation of the environment 190.

Another input 502c is a camera system. A camera system uses one or more cameras (e.g., digital cameras using a light sensor such as a charge-coupled device [CCD]) to obtain information about nearby physical objects. A camera system produces camera data as output 504c. Camera data often takes the form of image data (e.g., data in an image data format such as RAW, JPEG, PNG, etc.). In some examples, the camera system has multiple independent cameras, e.g., for the purpose of stereopsis (stereo vision), which enables the camera system to perceive depth. Although the objects perceived by the camera system are described here as “nearby,” this is relative to the AV. In some embodiments, the camera system is configured to “see” objects far, e.g., up to a kilometer or more ahead of the AV. Accordingly, in some embodiments, the camera system has features such as sensors and lenses that are optimized for perceiving objects that are far away.

Another input 502d is a traffic light detection (TLD) system. A TLD system uses one or more cameras to obtain information about traffic lights, street signs, and other physical objects that provide visual navigation information. A TLD system produces TLD data as output 504d. TLD data often takes the form of image data (e.g., data in an image data format such as RAW, JPEG, PNG, etc.). A TLD system differs from a system incorporating a camera in that a TLD system uses a camera with a wide field of view (e.g., using a wide-angle lens or a fish-eye lens) in order to obtain information about as many physical objects providing visual navigation information as possible, so that the AV 100 has access to all relevant navigation information provided by these objects. For example, the viewing angle of the TLD system is about 120 degrees or more.

In some embodiments, outputs 504a-d are combined using a sensor fusion technique. Thus, either the individual outputs 504a-d are provided to other systems of the AV 100 (e.g., provided to a planning module 404 as shown in FIGS. 4A and 4B), or the combined output can be provided to the other systems, either in the form of a single combined output or multiple combined outputs of the same type (e.g., using the same combination technique or combining the same outputs or both) or different types type (e.g., using different respective combination techniques or combining different respective outputs or both). In some embodiments, an early fusion technique is used. An early fusion technique is characterized by combining outputs before one or more data processing steps are applied to the combined output. In some embodiments, a late fusion technique is used. A late fusion technique is characterized by combining outputs after one or more data processing steps are applied to the individual outputs.

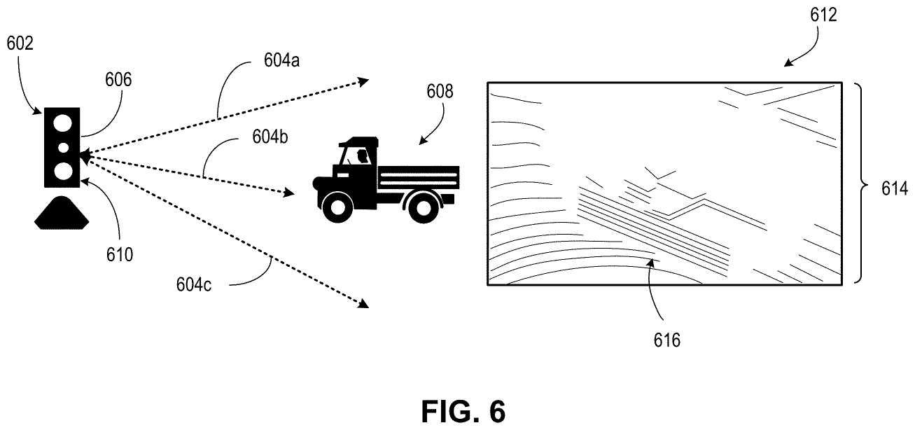

FIG. 6 shows an example of a LiDAR system 602 (e.g., the input 502a shown in FIG. 5). The LiDAR system 602 emits light 604a-c from a light emitter 606 (e.g., a laser transmitter). Light emitted by a LiDAR system is typically not in the visible spectrum; for example, infrared light is often used. Some of the light 604b emitted encounters a physical object 608 (e.g., a vehicle) and reflects back to the LiDAR system 602. (Light emitted from a LiDAR system typically does not penetrate physical objects, e.g., physical objects in solid form.) The LiDAR system 602 also has one or more light detectors 610, which detect the reflected light. In an embodiment, one or more data processing systems associated with the LiDAR system generates an image 612 representing the field of view 614 of the LiDAR system. The image 612 includes information that represents the boundaries 616 of a physical object 608. In this way, the image 612 is used to determine the boundaries 616 of one or more physical objects near an AV.

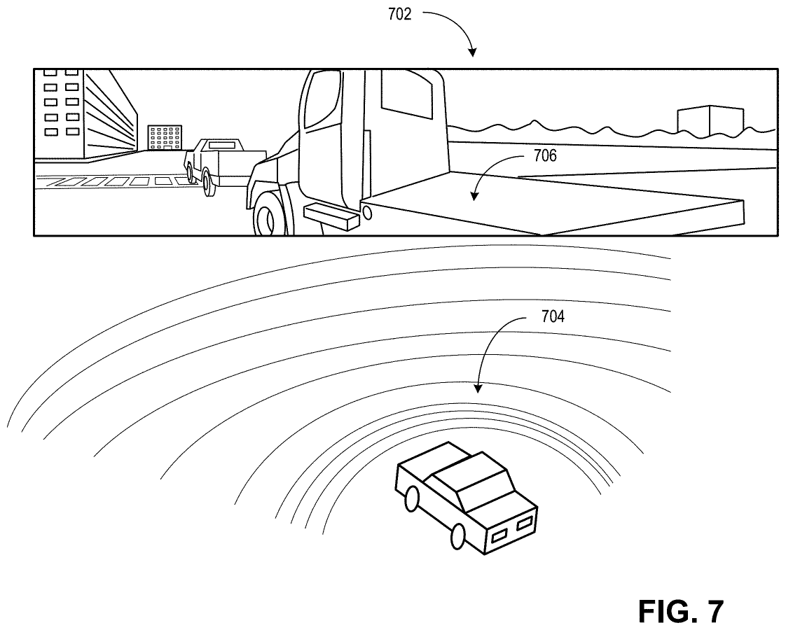

FIG. 7 shows the LiDAR system 602 in operation. In the scenario shown in this figure, the AV 100 receives both camera system output 504c in the form of an image 702 and LiDAR system output 504a in the form of LiDAR data points 704. In use, the data processing systems of the AV 100 compares the image 702 to the data points 704. In particular, a physical object 706 identified in the image 702 is also identified among the data points 704. In this way, the AV 100 perceives the boundaries of the physical object based on the contour and density of the data points 704.

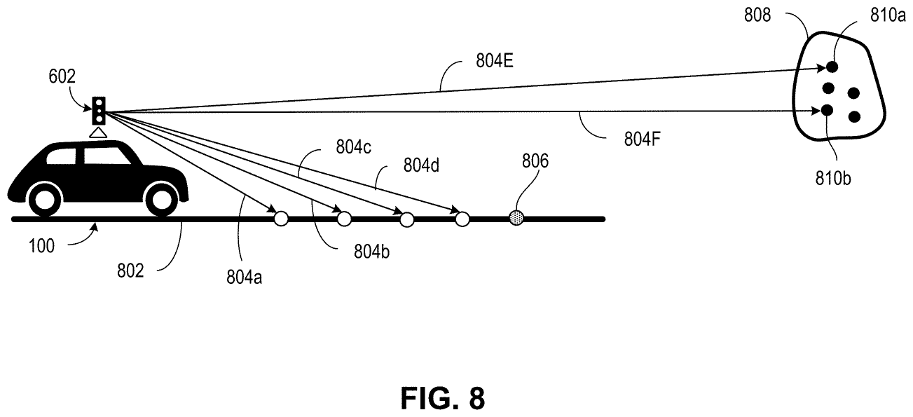

FIG. 8 shows the operation of the LiDAR system 602 in additional detail. As described above, the AV 100 detects the boundary of a physical object based on characteristics of the data points detected by the LiDAR system 602. As shown in FIG. 8, a flat object, such as the ground 802, will reflect light 804a-d emitted from a LiDAR system 602 in a consistent manner. Put another way, because the LiDAR system 602 emits light using consistent spacing, the ground 802 will reflect light back to the LiDAR system 602 with the same consistent spacing. As the AV 100 travels over the ground 802, the LiDAR system 602 will continue to detect light reflected by the next valid ground point 806 if nothing is obstructing the road. However, if an object 808 obstructs the road, light 804e-f emitted by the LiDAR system 602 will be reflected from points 810a-b in a manner inconsistent with the expected consistent manner. From this information, the AV 100 can determine that the object 808 is present.

### Path Planning

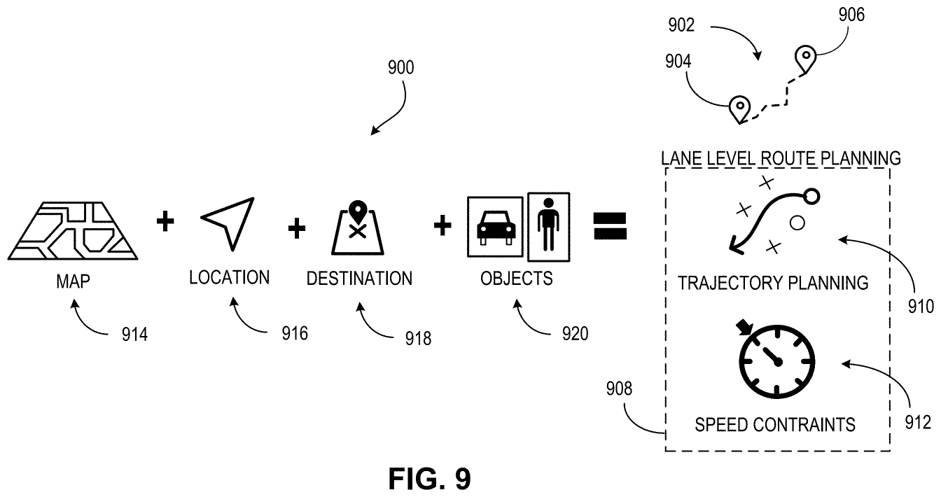

FIG. 9 shows a block diagram 900 of the relationships between inputs and outputs of a planning module 404 (e.g., as shown in FIGS. 4A and 4B). In general, the output of a planning module 404 is a route 902 from a start point 904 (e.g., source location or initial location), and an end point 906 (e.g., destination or final location). The route 902 is typically defined by one or more segments. For example, a segment is a distance to be traveled over at least a portion of a street, road, highway, driveway, or other physical area appropriate for automobile travel. In some examples, e.g., if the AV 100 is an off-road capable vehicle such as a four-wheel-drive (4WD) or all-wheel-drive (AWD) car, SUV, pick-up truck, or the like, the route 902 includes “off-road” segments such as unpaved paths or open fields.

In addition to the route 902, a planning module also outputs lane-level route planning data 908. The lane-level route planning data 908 is used to traverse segments of the route 902 based on conditions of the segment at a particular time. For example, if the route 902 includes a multi-lane highway, the lane-level route planning data 908 includes trajectory planning data 910 that the AV 100 can use to choose a lane among the multiple lanes, e.g., based on whether an exit is approaching, whether one or more of the lanes have other vehicles, or other factors that vary over the course of a few minutes or less. Similarly, in some implementations, the lane-level route planning data 908 includes speed constraints 912 specific to a segment of the route 902. For example, if the segment includes pedestrians or un-expected traffic, the speed constraints 912 can limit the AV 100 to a travel speed slower than an expected speed, e.g., a speed based on speed limit data for the segment.

In an embodiment, the inputs to the planning module 404 includes database data 914 (e.g., from the database module 410 shown in FIG. 4A), current location data 916 (e.g., the AV position 418 shown in FIG. 4A), destination data 918 (e.g., for the destination 412 shown in FIG. 4A), and object data 920 (e.g., the classified objects 416 as perceived by the perception module 402 as shown in FIG. 4A). In some embodiments, the database data 914 includes rules used in planning, also referred to as a “rulebook.” Rules are specified using a formal language, e.g., using Boolean logic or linear temporal logic (LTL). In any given situation encountered by the AV 100, at least some of the rules will apply to the situation. A rule applies to a given situation if the rule has conditions that are met based on information available to the AV 100, e.g., information about the surrounding environment. Rules can have priority. For example, a rule that says, “if the road is a freeway, move to the leftmost lane” can have a lower priority than “if the exit is approaching within a mile, move to the rightmost lane.”

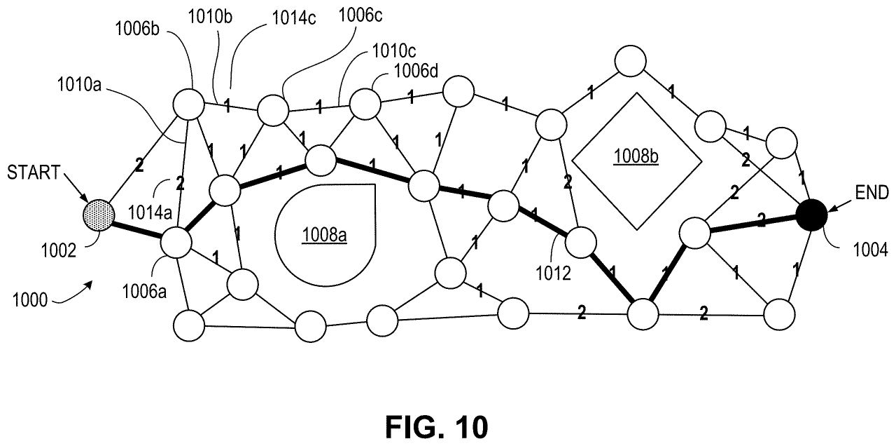

FIG. 10 shows a directed graph 1000 used in path planning, e.g., by the planning module 404 (FIGS. 4A and 4B). In general, a directed graph 1000 like the one shown in FIG. 10 is used to determine a path between any start point 1002 and end point 1004. In real-world terms, the distance separating the start point 1002 and end point 1004 can be relatively large (e.g., in two different metropolitan areas) or can be relatively small (e.g., two intersections abutting a city block or two lanes of a multi-lane road).

In an embodiment, the directed graph 1000 has nodes 1006a-d representing different locations between the start point 1002 and the end point 1004 that could be occupied by an AV 100. In some examples, e.g., when the start point 1002 and end point 1004 represent different metropolitan areas, the nodes 1006a-d represent segments of roads. In some examples, e.g., when the start point 1002 and the end point 1004 represent different locations on the same road, the nodes 1006a-d represent different positions on that road. In this way, the directed graph 1000 includes information at varying levels of granularity. In an embodiment, a directed graph having high granularity is also a subgraph of another directed graph having a larger scale. For example, a directed graph in which the start point 1002 and the end point 1004 are far away (e.g., many miles apart) has most of its information at a low granularity and is based on stored data, but also includes some high granularity information for the portion of the graph that represents physical locations in the field of view of the AV 100.

The nodes 1006a-d are distinct from objects 1008a-b which cannot overlap with a node. In an embodiment, when granularity is low, the objects 1008a-b represent regions that cannot be traversed by automobile, e.g., areas that have no streets or roads. When granularity is high, the objects 1008a-b represent physical objects in the field of view of the AV 100, e.g., other automobiles, pedestrians, or other entities with which the AV 100 cannot share physical space. In an embodiment, some or all of the objects 1008a-b are a static objects (e.g., an object that does not change position such as a street lamp or utility pole) or dynamic objects (e.g., an object that is capable of changing position such as a pedestrian or other car).

The nodes 1006a-d are connected by edges 1010a-c. If two nodes 1006a-b are connected by an edge 1010a, it is possible for an AV 100 to travel between one node 1006a and the other node 1006b, e.g., without having to travel to an intermediate node before arriving at the other node 1006b. (i.e., the AV 100 travels between the two physical positions represented by the respective nodes). The edges 1010a-c are often bidirectional, in the sense that an AV 100 travels from a first node to a second node, or from the second node to the first node. In an embodiment, edges 1010a-c are unidirectional, in the sense that an AV 100 can travel from a first node to a second node, however the AV 100 cannot travel from the second node to the first node. Edges 1010a-c are unidirectional when they represent, for example, one-way streets, individual lanes of a street, road, or highway, or other features that can only be traversed in one direction due to legal or map constraints.

In an embodiment, the planning module 404 uses the directed graph 1000 to identify a path 1012 made up of nodes and edges between the start point 1002 and end point 1004.

An edge 1010a-c has an associated cost 1014a-b. The cost 1014a-b is a value that represents the resources that will be expended if the AV 100 chooses that edge. A typical resource is time. For example, if one edge 1010a represents a physical distance that is twice that as another edge 1010b, then the associated cost 1014a of the first edge 1010a can be twice the associated cost 1014b of the second edge 1010b. Other factors that affect time include expected traffic, number of intersections, speed limit, etc. Another typical resource is fuel economy. Two edges 1010a-b can represent the same physical distance, but one edge 1010a can require more fuel than another edge 1010b, e.g., because of road conditions, expected weather, etc.

When the planning module 404 identifies a path 1012 between the start point 1002 and end point 1004, the planning module 404 typically chooses a path optimized for cost, e.g., the path that has the least total cost when the individual costs of the edges are added together.

### AV Control

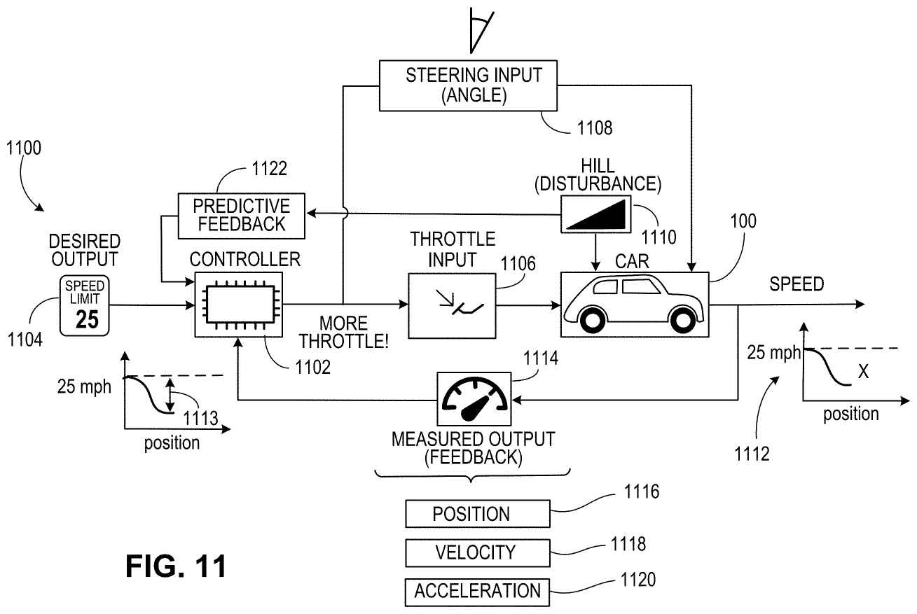

FIG. 11 shows a block diagram 1100 of the inputs and outputs of a control module 406 (e.g., as shown in FIG. 4A). A control module operates in accordance with a controller 1102 which includes, for example, one or more processors (e.g., one or more computer processors such as microprocessors or microcontrollers or both) similar to processor 304, short-term and/or long-term data storage (e.g., memory random-access memory or flash memory or both) similar to main memory 306, ROM 308, and storage device 310, and instructions stored in memory that carry out operations of the controller 1102 when the instructions are executed (e.g., by the one or more processors).

In an embodiment, the controller 1102 receives data representing a desired output 1104. The desired output 1104 typically includes a velocity, e.g., a speed and a heading. The desired output 1104 can be based on, for example, data received from a planning module 404 (e.g., as shown in FIGS. 4A and 4B). In accordance with the desired output 1104, the controller 1102 produces data usable as a throttle input 1106 and a steering input 1108. The throttle input 1106 represents the magnitude in which to engage the throttle (e.g., acceleration control) of an AV 100, e.g., by engaging the steering pedal, or engaging another throttle control, to achieve the desired output 1104. In some examples, the throttle input 1106 also includes data usable to engage the brake (e.g., deceleration control) of the AV 100. The steering input 1108 represents a steering angle, e.g., the angle at which the steering control (e.g., steering wheel, steering angle actuator, or other functionality for controlling steering angle) of the AV should be positioned to achieve the desired output 1104.

In an embodiment, the controller 1102 receives feedback that is used in adjusting the inputs provided to the throttle and steering. For example, if the AV 100 encounters a disturbance 1110, such as a hill, the measured speed 1112 of the AV 100 is lowered below the desired output speed. In an embodiment, any measured output 1114 is provided to the controller 1102 so that the necessary adjustments are performed, e.g., based on the differential 1113 between the measured speed and desired output. The measured output 1114 includes measured position 1116, measured velocity 1118, (including speed and heading), measured acceleration 1120, and other outputs measurable by sensors of the AV 100.

In an embodiment, information about the disturbance 1110 is detected in advance, e.g., by a sensor such as a camera or LiDAR sensor, and provided to a predictive feedback module 1122. The predictive feedback module 1122 then provides information to the controller 1102 that the controller 1102 can use to adjust accordingly. For example, if the sensors of the AV 100 detect (“see”) a hill, this information can be used by the controller 1102 to prepare to engage the throttle at the appropriate time to avoid significant deceleration.

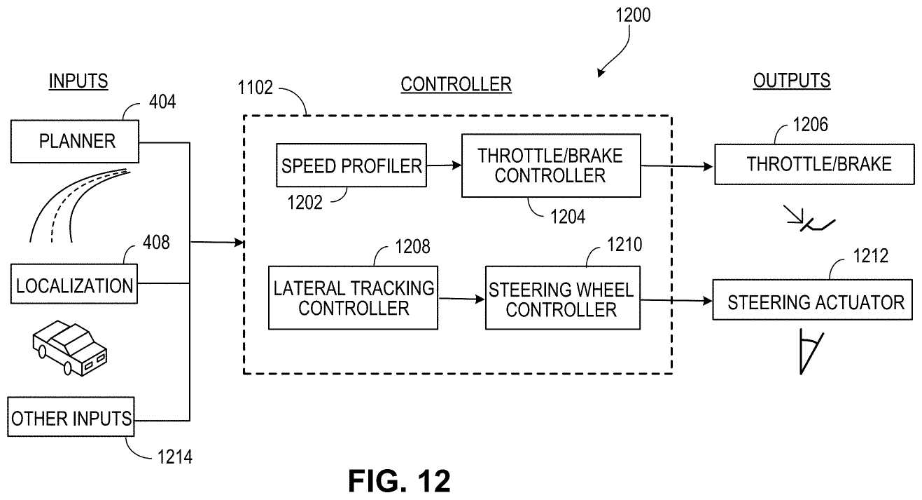

FIG. 12 shows a block diagram 1200 of the inputs, outputs, and components of the controller 1102. The controller 1102 has a speed profiler 1202 which affects the operation of a throttle/brake controller 1204. For example, the speed profiler 1202 instructs the throttle/brake controller 1204 to engage acceleration or engage deceleration using the throttle/brake 1206 depending on, e.g., feedback received by the controller 1102 and processed by the speed profiler 1202.

The controller 1102 also has a lateral tracking controller 1208 which affects the operation of a steering controller 1210. For example, the lateral tracking controller 1208 instructs the steering controller 1210 to adjust the position of the steering angle actuator 1212 depending on, e.g., feedback received by the controller 1102 and processed by the lateral tracking controller 1208.

The controller 1102 receives several inputs used to determine how to control the throttle/brake 1206 and steering angle actuator 1212. A planning module 404 provides information used by the controller 1102, for example, to choose a heading when the AV 100 begins operation and to determine which road segment to traverse when the AV 100 reaches an intersection. A localization module 408 provides information to the controller 1102 describing the current location of the AV 100, for example, so that the controller 1102 can determine if the AV 100 is at a location expected based on the manner in which the throttle/brake 1206 and steering angle actuator 1212 are being controlled. In an embodiment, the controller 1102 receives information from other inputs 1214, e.g., information received from databases, computer networks, etc.

### Homotopic-Based Planner

As described herein (e.g., with respect to FIGS. 4, 9, and 10), a planning module 404 can receive data representing a destination. Further, the planning module 404 can receive data from one or more modules described above (e.g., data from a perception module 402, a localization module 408, a database module 410, etc.). As an example, the data can represent nearby physical objects using one or more sensors, the position of the AV, geographical data, or any other data described herein. Further, using this data, the planning module 404 can determine (e.g., generate) data representing a trajectory that can be traveled by the AV to reach the destination.

In some implementations, the planning module 404 can determine a trajectory in a brute force manner by (i) generating a large number of candidate trajectories (e.g., to account for every possible trajectory that the AV might take along the route), (ii) evaluating each of the candidate trajectories, and (iii) selecting a particular candidate trajectory for execution. However, it can be computationally expensive to generate and evaluate each of the trajectories across such a large search space (e.g., a search space that includes every possible trajectory).

To reduce the search space, in some implementations, the planning module 404 can determine a trajectory for an AV (e.g., the AV system 120) based on a “homotopic”-based approach. As an example, the planning module 404 can determine a route for an AV, and determine several candidate constraints for traversing the route. Further, the planning module 404 can determine feasible homotopies of those constraints (e.g., combinations of constraints that the AV is capable of adhering to safely while traversing the route, such as without violating any traffic laws and without coming into contact with any obstacle, vehicles, pedestrians, etc.). Further, the planning module 404 can generate trajectories for each of the feasible homotopies (while foregoing generating trajectories for infeasible homotopies), and select one of the trajectories for execution by the AV. Accordingly, a trajectory can be selected more quickly and efficiently.

In some implementations, the techniques described herein can be performed with respect to a subset of the road segments that make up a route. In some implementations, the techniques described herein can be performed with respect to all of the road segments that make up a route.

FIG. 13 shows an example process 1300 for determining a trajectory for an AV based on a “homotopic”-based approach. In some implementations, the process 1300 can be performed, at least in part, using the homotopy extractor 453 of the planning module 404 of the AV 100 (e.g., as described with respect to FIGS. 4A and 4B).

As shown in FIG. 13, the homotopy extractor 453 can generate a set of candidate constraints 1302 associated with the AV traversing one or more road segments of a route to a destination (e.g., a constraint on a trajectory that the AV can adhere to while traversing the route). In some implementations, each candidate constraint of the candidate constraints 1302 can include a particular parameter and a corresponding parameter value. For example, one candidate constraint can be that a particular parameter C₁ be equal to a particular parameter value X₁. As another example, another candidate constraint can be that the same parameter C₁ equal to a different parameter value X₂. As another example, another candidate constraint can be that a different parameter C₂ equal to a parameter value Y₁.

In some implementations, at least some of the candidate constraints 1302 can be optional or “soft” (e.g., the AV does not necessarily need to adhere to those candidate constraints while traversing to the destination). In some implementations, at least some of the candidate constraints 1302 can be required or “hard” (e.g., the AV must adhere to those candidate constraints while traversing to the destination).

The candidate constraints 1302 can represent any aspect that may restrict, control, or otherwise influence the operation of the AV as it traverses to the destination.

As an example, at least some of the candidate constraints 1302 can pertain to the performance capabilities of the AV. For instance, one or more candidate constraints 1302 can specify that the AV is to adhere to certain map constraints based on the performance capabilities of the AV, including but not limited to: acceleration limitations, braking limitations, speed limitations, turning rate limitations, inertial limitations, etc. As another example, one of more candidate constraint 1032 can specify a range of motion of the AV (e.g., the AV can travel forward or backward, while remaining straight or turning, but cannot travel side to side).

As another example, at least some of the candidate constraints 1302 can be map constraints that pertain to the map geometry of one or more roads that that AV can use to traverse to the destination. For instance, one or more candidate constraints 1302 can specify that the AV is to be confined to certain lanes of a road and/or within certain boundaries of a road (e.g., between the left and right edges of a navigable portion of a road). As another example, one or more candidate constraints 1302 can specify that presence and location of obstacles on a road, through which an AV cannot pass.

As another example, at least some of the candidate constraints 1302 can pertain to legal constraints regarding an operation of the AV. For instance, one or more candidate constraints 1302 specify that the AV is to adhere to a particular speed limit of a road and/or a particular flow of traffic of a road (e.g., a direction of travel). As another example, one or more candidate constraints can specify that the AV is to adhere to traffic rules or laws in a particular jurisdiction.

As another example, at least some of the candidate constraints 1302 can pertain to a predicted comfort of one or more passengers of the AV. For instance, one or more candidate constraints 1302 can specify that the AV adhere to certain acceleration limitations, braking limitations, speed limitations, turning rate limitations, etc. based on the effect these constraints have on the comfort of a passenger of the AV.

As another example, at least some of the candidate constraints 1302 can pertain to a predicted safety of one or more passengers of the AV and/or the safety of the AV. For instance, one or more candidate constraints 1302 can specify that the AV not make contact with certain objects (e.g., other vehicles, pedestrians, obstacles, etc.), remain within the boundaries of a road, travel in a direction of traffic of a road, not accelerate or decelerate in a manner that would injury its passengers, etc. As another example, at least some of the candidate constraints 1302 can specify that a likelihood of the AV colliding in an obstacle, vehicle, pedestrian, or other object be less than a threshold value. In some implementations, the likelihood can be calculated by the homotopy extractor 453 using one or more computer simulations or dynamic models.

As another example, at least some of the candidate constraints 1302 can specify that the AV perform certain operations or tasks. For instance, a candidate constraint can specify that an AV perform a particular maneuver. As an example, a candidate constraint can specify that the AV change lanes on a road at a particular time and location. As another example, a candidate constraint can specify that the AV remain in its current location at a particular time and location. As another example, a candidate constraint can specify that the AV overtake a particular vehicle at a particular time and location. As another example, candidate constraint can specify that the AV remain behind a particular vehicle at a particular time and location. As another example, candidate constraint can specify that the AV wait for a vehicle or a pedestrian to clear the path of the AV before proceeding further along the path. As another example, candidate constraint can specify that the AV proceed along a path prior to a vehicle or a pedestrian entering the path.

Although example candidate constraints 1302 are described herein, these are merely illustrative examples. In practice, candidate constraints 1302 can include additional constraints, either instead of or in addition to those described herein.

The homotopy extractor 453 can generate one or more homotopies 1304a-1304n based on the candidate constraints 1302. Each homotopy can include a different respective subset of the candidate constraints 1302. For example, each homotopy can include a different one of the candidate constraints 1302 and/or a different combination of two or more of the candidate constraints 1302.

In some implementations, each homotopy can include one or more of the “optional” candidate constraints 1302. Further, each homotopy can include each of the “required” candidate restraints 1302. In practice, whether a particular candidate restraint is “optional” or “required” can vary, depending on the implementation. As an example, in some implementations, candidate constraints 1302 pertaining to the performance capabilities of the AV, the map constraints of one or more roads that that AV can use to traverse to the destination, the legal constraints regarding an operation of the AV, and/or the safety of one or more passengers of the AV may be considered “required.” As another example, in some implementations, candidate constraints 1302 pertaining to comfort of one or more passengers of the AV and/or candidate constraints 1302 specifying that the AV perform certain operations or tasks may be considered “optional.”

In the example shown in FIG. 13, a first homotopy 1304a (“Homotopy 1”) includes (i) the “optional” candidate constraint that a parameter C₁ be equal to a parameter value X₁, (ii) the “optional” candidate constraint that a parameter C₂ be equal to a parameter value Y₂, and (iii) each of the “required” candidate constraints.

Further, a second homotopy 1304b (“Homotopy 2”) includes (i) the “optional” candidate constraint that the parameter C₁ be equal to the parameter value X₁ (as in the Homotopy 1), (ii) the “optional” candidate constraint that the parameter C₂ be equal to the parameter value Y₂ (as in the Homotopy 1), (iii) an additional “optional” candidate constraint that a parameter C_{N} be equal to a parameter value Z₁, and (iv) each of the “required” candidate constraints (as in the Homotopy 1). That is, although the Homotopy 2 shares some of the same candidate constraints as in the Homotopy 2, it includes an additional constraint that is not in the Homotopy 1.

Further, a third homotopy 1304n (“Homotopy N”) includes (i) the “optional” candidate constraint that the parameter C₁ be equal to the parameter value X₁ (as in the Homotopies 1 and 2), (ii) the “optional” candidate constraint that the parameter C₂ be equal to the parameter value Y₂ (as in the Homotopies 1 and 2), (iii) the “optional” candidate constraint that a parameter C_{N} be equal to a parameter value Z₂, and (iv) each of the “required” candidate constraints (as in the Homotopies 1 and 2). That is, although the Homotopy 3 shares some of the same candidate constraints as in the Homotopies 1 and 2, it specifies a different parameter value for one of its candidate constraints.

Although three example homotopies are shown in FIG. 13, this is merely an illustrative example. In practice, the homotopy extractor 453 can generate any number of homotopies, each having a different respective subset of the candidate constraints 1302.

The homotopy extractor 453 determines whether each of the homotopies 1304a-1304n is “feasible.” As an example, for each homotopy, the homotopy extractor 453 can determine whether the AV can traverse to the destination in accordance with the candidate constraints of that homotopy, without colliding with other objects on the road, without negatively impacting the safety of its passengers, without violating traffic rules or laws of the jurisdictions, etc.

In some implementations, the homotopy extractor 453 can determine whether each of the homotopies 1304a-1304n is feasible by predicting the motion of the AV. For example, for each homotopy, the homotopy extractor 453 performs a simulation of the AV motion using computer simulation or a dynamic model to predict how the AV will move as it traverses a road segment, while attempting to adhere to each of the candidate constraints of that homotopy. If the homotopy extractor 453 determines that the AV is unable to traverse the road segment while adhering to each of the candidate constraints of that homotopy, the homotopy extractor 453 determines that the homotopy is “not feasible.” If the homotopy extractor 453 determines that the AV is able to traverse the road segment while adhering to each of the candidate constraints of that homotopy, the homotopy extractor 453 determines that the homotopy is “feasible.”

As an example, a homotopy can include a subset of candidate constraints specifying that: (i) the AV perform certain operations and tasks at certain times and locations; (ii) the AV adhere to all traffic rules and laws in the jurisdiction; (iii) the AV perform in a manner that does not exceed its performance capabilities; and (iv) the AV does not collide with any objects or obstacles on the road. The homotopy extractor 453 can simulate the motion of the AV in accordance with these candidate constraints. If the homotopy extractor 453 determines that the AV cannot perform the specified operations and tasks unless it violates certain traffic rules or laws, the homotopy extractor 453 determines that the homotopy is “not feasible.” Similarly, if the homotopy extractor 453 determines that the AV cannot perform the specified operations and tasks without colliding with another object, the homotopy extractor 453 also determines that the homotopy is “not feasible.” Similarly, if the homotopy extractor 453 determines that performing the specified operations and tasks would require exceeding the performance capabilities of the AV, the homotopy extractor 453 also determines that the homotopy is “not feasible.” However, if the homotopy extractor 453 determines that the AV can perform the specified operations and tasks, and without violating any of the other constraints, the homotopy extractor 453 determines that the homotopy is “feasible.”

For instance, in the example shown in FIG. 13, the homotopy extractor 453 determines that the Homotopies 1 and N are “feasible,” and that the Homotopy 2 is “not feasible” (e.g., due to violation of one or more of the candidate constraints 1302 specified by the Homotopy 2).

Further, the homotopy extractor 453 can determine whether each of the homotopies 1304a-1304n is “feasible” according to a first degree of precision.

The planning module 404 generates one or more trajectories for each of the homotopies that are determined to be “feasible,” and refrains from generating trajectories for each of the homotopies that are determined to be “not feasible.” For example, for each homotopy that is determined to be “feasible,” the planning module 404 (e.g., using the sample-based maneuver realizer 454) can use a computer simulation and one or more dynamic models, control laws and equations of motion of the AV to generate one or more trajectories for the AV that enable it to traverse the road segment, while adhering to each of the candidate constraints of that homotopy. In some implementations, a simulation and/or a dynamic models can be implemented using one or more equations and/or control laws specifying a motion of one or more objects in an environment. Example techniques for generating one or more trajectories for an AV are described herein (e.g., with respect to FIGS. 4A, 4B, 9, and 10).

For instance, in the example shown in FIG. 13, the planning module 404 (e.g., using the sample-based maneuver realizer 454) generates one or more trajectories 1306a corresponding to the Homotopy 1, and one or more trajectories 1306b corresponding to the Homotopy N (both of which were determined to be “feasible”). However, the planning module 404 refrains from generating any trajectories corresponding to the Homotopy 2 (which was determined to be “not feasible”).

In some implementations, the planning module 404 (e.g., using the sample-based maneuver realizer 454) can generate one or more trajectories for each of the homotopies that are determined to be “feasible” according to a second degree of precision. This second degree of precision can be higher than the first degree of precision.

In some implementations, the degree of precision with which the motion of an AV is predicted and/or a trajectory for an AV is generated can refer to one or more of the following: (i) the spatial resolution with which the motion of an AV is predicted and/or a trajectory for an AV is generated, (ii) the temporal resolution with which the motion of an AV is predicted and/or a trajectory for an AV is generated, (iii) the complexity of the computer simulations or dynamic models that are used to predict the motion of an AV and/or generate a trajectory for an AV is generated, (iv) the amount of computation resources are allotted to predicting the motion of an AV and/or generating a trajectory for an AV, (v) the tolerance or error range associated with predicting the motion of an AV and/or generating a trajectory for an AV, and/or other such characteristics that can influence how the motion of an AV can predicted and/or a trajectory for an AV can be generated.

As an example, the homotopy extractor 453 can initially generate predictions for each of the homotopies according to a first spatial and/or temporal resolution. Subsequently, the planning module 404 (e.g., using the sample-based maneuver realizer 454) can generate one or more trajectories for each of the homotopies that are determined to be “feasible” according to a higher second spatial and/or temporal resolution. For instance, the homotopy extractor 453 can initially predict, for each of the homotopies, a motion of the AV according to a lower spatial resolution (e.g., in 10 feet increments). Subsequently, the planning module 404 (e.g., using the sample-based maneuver realizer 454) can generate one or more trajectories for each of the homotopies that are determined to be “feasible” according to a higher spatial resolution (e.g., 1 foot increments). As an example, the homotopy extractor 453 can initially predict, for each of the homotopies, a motion of the AV according to a lower temporal resolution (e.g., in 10 second increments). Subsequently, the sample-based maneuver realizer 454) can generate one or more trajectories for each of the homotopies that are determined to be “feasible” according to a higher spatial resolution (e.g., 1 second increments). Although example spatial and/or temporal resolutions are described above, these are merely illustrative examples. In practice, other spatial and/or temporal resolutions can be used to predict a motion of and AV and/or generate one or more trajectories for an AV.

As another example, the homotopy extractor 453 can initially generate predictions for each of the homotopies according to a first computer simulation or first dynamic model). Subsequently, the sample-based maneuver realizer 454 can generate one or more trajectories for each of the homotopies that are determined to be “feasible” according to a second computer simulation or second dynamic model that is more complex than the first computer simulation or the first dynamic model (e.g., more variables and/or parameters are modeled). For instance, the first computer simulation or dynamic model can require fewer computational resources to generate a prediction (but can be less precise), whereas the first computer simulation or dynamic model may require more computation resources to generate a trajectory (but can be more precise). As another example, the first computer simulation or dynamic model can require fewer data inputs and/or less comprehensive data inputs to generate a prediction (but can be less precise), whereas the first computer simulation or dynamic model can require more data inputs and/or more comprehensive data inputs to generate a trajectory (but can be more precise). Example data inputs can include, for example, sensor data, traffic data, weather data, and/or other data that regarding the characteristics of an environment of the AV.

The planning module 404 (e.g., using the trajectory score generator 455) selects one of the generated trajectories 1306a and 1306b, and instructs the AV to execute the selected trajectory, such as by providing the selected trajectory to the tracking controller 456. For instance, in the example shown in FIG. 13, the trajectory score generator 455 has selected the trajectory 1306a (“Trajectory 1”) over the trajectory 1306b (“Trajectory N”).

As described above (e.g., with reference to FIG. 4B), the tracking controller 456 can generate steady and smooth control inputs for the AV based on the selected trajectory, and provide the inputs to the appropriate sub-systems of the AV for execution. As an example, the tracking controller 456 can generate throttle inputs, steering inputs, and/or braking inputs based on the selected trajectory, and provide each of the inputs to the appropriate sub-systems of the AV for execution.

In some implementations, one of the generated trajectories can be selected by calculating a quality score or other metric for each of the trajectories, and selecting the trajectory based on the quality scores or metrics. For example, for each trajectory, a quality score or metric based on various factors, such as the predicted safety or the passengers of the AV, the predicted comfort of the passengers of the AV, the predicted resources that would consumed by the AV (e.g., fuel, battery charge, etc.), the predicted amount of time that it would take to transverse to the destination, and/or other factors. The one of the trajectories can be selected based on the quality scores or metrics (e.g., the trajectory having the highest quality score or metric).

In some implementations, each of the factors can have a different respective weight, such that certain factors can have a greater influence on the quality score or metric than other factors. For example, if passenger safety is more important than resource consumption, the passenger safety can be assigned a greater weight when calculating the quality score or metric. In some implementations, a quality score or metric can be calculated using a weighted sum as a scoring function. As an example, the quality score or metric Q for a trajectory T can be calculated using the function:

Q_{T}=w₁x₁+w₂x₂, . . . +wₙxₙ,

where xᵢ is a sub-score associated with a particular factor of the trajectory T (e.g., safety, resource consumption, time required to traverse the trajectory, etc.), and wᵢ is the weight assigned to that sub-score. In some implementations, a higher value for xᵢ can indicate that the trajectory is more desirable with respect to a particular factor of the trajectory (e.g., more safe, requires fewer resources to be consumed, requires less time to traverse, etc.). In some implementations, a higher value for wᵢ indicates that its corresponding factor be given greater weight in calculating the quality score or metric.

In some implementations, the planning module 404 (e.g., using the realization sample-based maneuver realizer 454) can also determine one or more emergency maneuvers 1308 that can override the trajectories generated based on the homotopies 1304a-1304n. For example, an emergency maneuver can correspond to an evasive action (e.g., a sudden turn, braking, acceleration, lane change, etc.) to avoid an unsafe or otherwise undesirable outcome (e.g., a collision, running off the road, etc.). In some implementations, the planning module 404 can plan the emergency maneuver independent from the generated trajectories, and selectively override the execution of a selected trajectory with the emergency maneuver based on one or more data inputs. Example data inputs can include, for instance, sensor data indicating that emergency action may be warranted, commands from a passenger of the AV indicating that an emergency action is to be performed, commands from a user that is remotely monitoring or controlling the AV indicating that an emergency action is to be performed, automated commands from a remote computer system indicating that an emergency action is to be performed, etc.

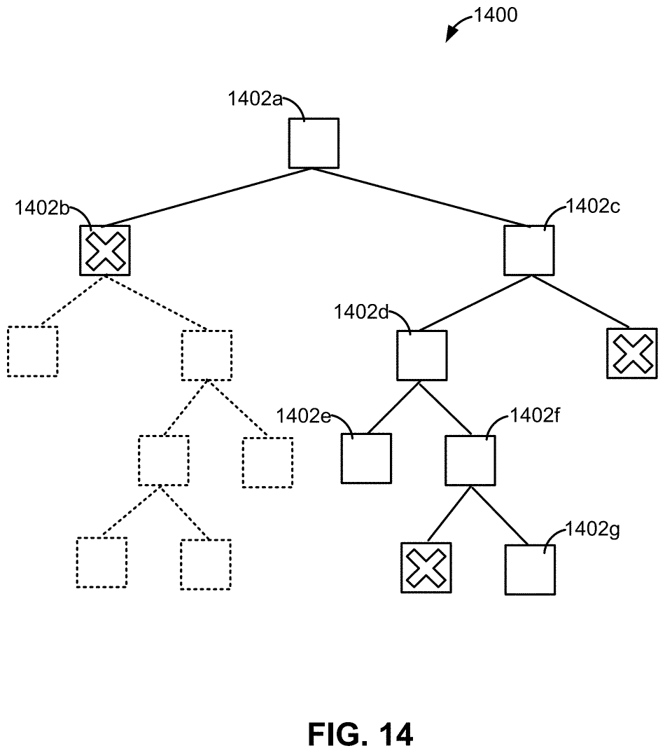

In some implementations, the homotopy extractor 453 can determine whether certain homotopies are “feasible” or “not feasible” based on a decision graph. As an illustrative example, a simplified decision graph 1400 is shown in FIG. 14.

The decision graph 1400 includes several interconnected nodes 1402, each corresponding to a different respective subset of candidate constraints. In some implementations, the nodes can be arranged hierarchically (e.g., according to different tiers of levels) and according to one or more branches, where a “child” node inherits the candidate constraints of its “parent” node and additionally includes one or more additional candidate constraints. In some implementations, the decision graph 1400 can be similar to the directed graph 1000 shown in FIG. 10.

The homotopy extractor 453 can determine the feasibility of traversing to the destination according to the candidate constraints of each node, beginning from the node having the highest level or tier, and progressing through the nodes of successively lower and levels or tiers. If the homotopy extractor 453 determines that it is not feasible to adhere to the candidate constraints of a particular node, the homotopy extractor 453 can refrain from assessing the feasibility of that node's children nodes.

For example, referring to FIG. 14, the homotopy extractor 453 determines that it is feasible to traverse to the destination according to the candidate constraints in of the highest level node 1402a. Based on this determination, the homotopy extractor 453 subsequently assesses the feasibility each of the children nodes 1402b and 1402c, and determines that it is not feasible to traverse to the destination according to the candidate constraints of the node 1402b, but that it is feasible to traverse to the destination according to the candidate constraints in the node 1402c. Based on this determination, the homotopy extractor 453 refrains from assessing the feasibility of any of the nodes that are dependent from the node 1402b, and continues assessing the feasibility of the nodes that are dependent from the node 1402c. The process described above can continue until each of the nodes in the decision graph 1400 have been assessed or omitted from assessment (due to a “not feasible” parent node).

In some implementations, the planning module 404 (e.g., using the realization sample-based maneuver realizer 454) can generate one or more candidate trajectories based on the nodes that were determined to be “feasible.” For example, referring to FIG. 14, the realization sample-based maneuver realizer 454 can generate one or more candidate trajectories for each of the nodes 1402a, 1402d, 1402e, 1402f, and/or 1402g. In some implementations, the planning module 404 can generate one or more candidate trajectories based on the nodes that were determined to be “feasible” and that also do not have any children nodes. For example, referring to FIG. 14, the realization sample-based maneuver realizer 454 can generate one or more candidate trajectories for each of the nodes 1402e and 1402g. As described above, the homotopy extractor 453 can determine a feasibility for each of the nodes according to a first degree of precision, and the realization sample-based maneuver realizer 454 can generate candidate trajectories according to second higher degree of precision.

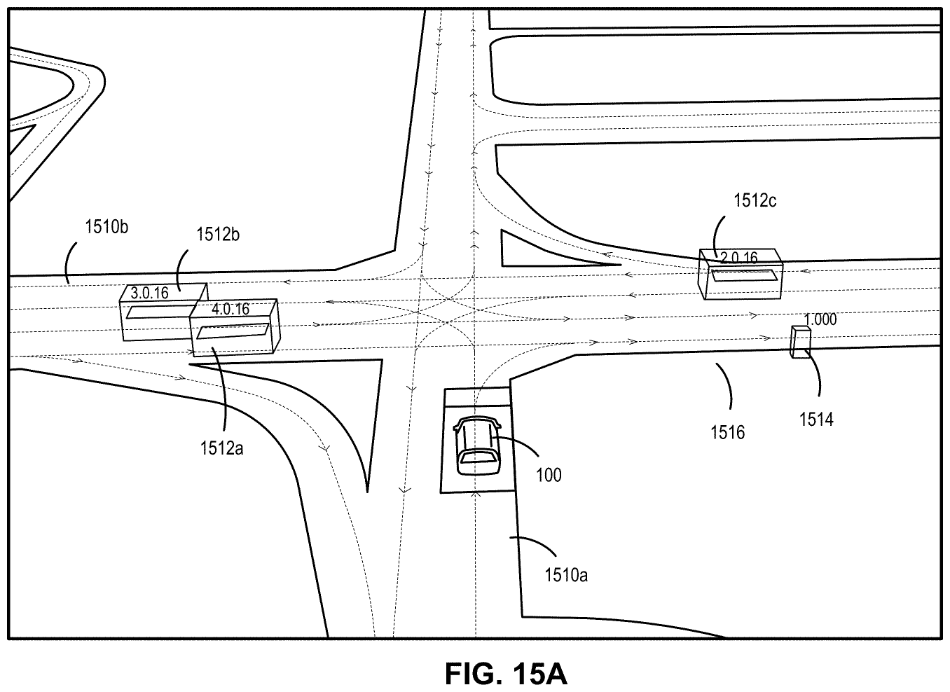

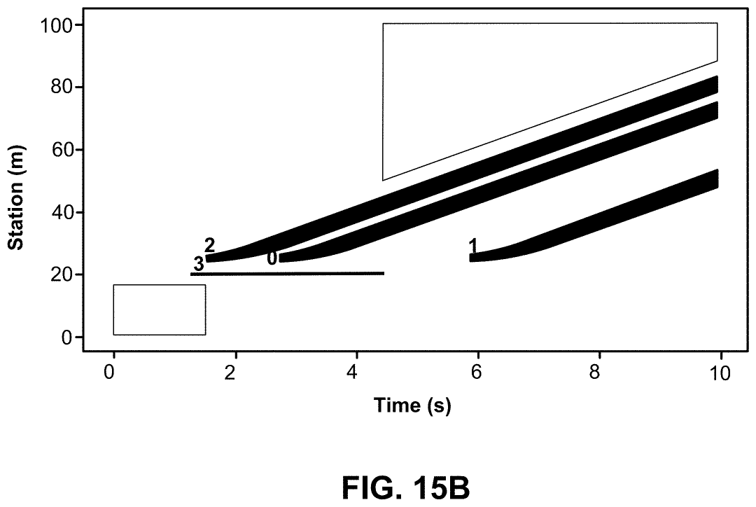

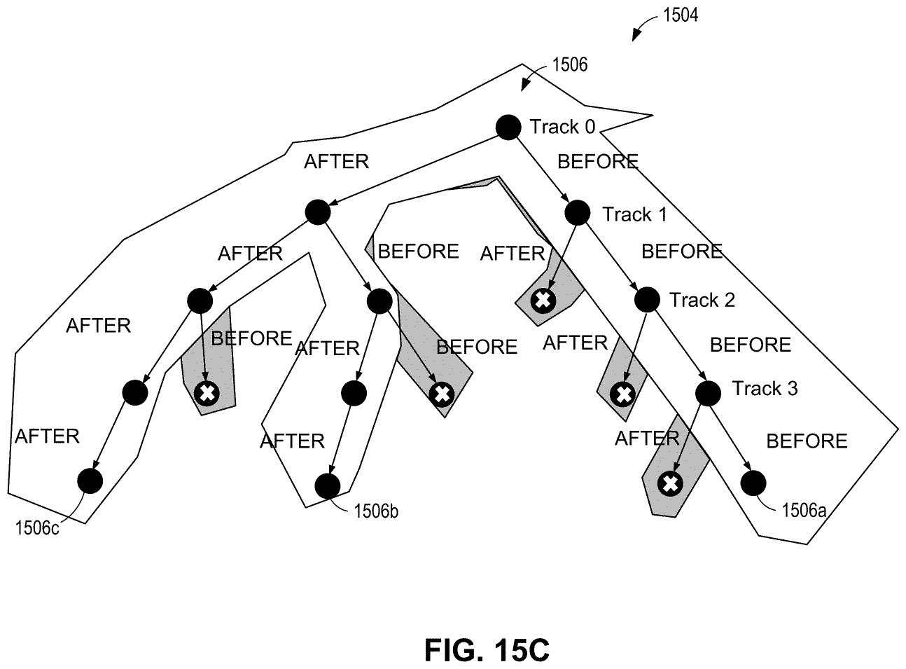

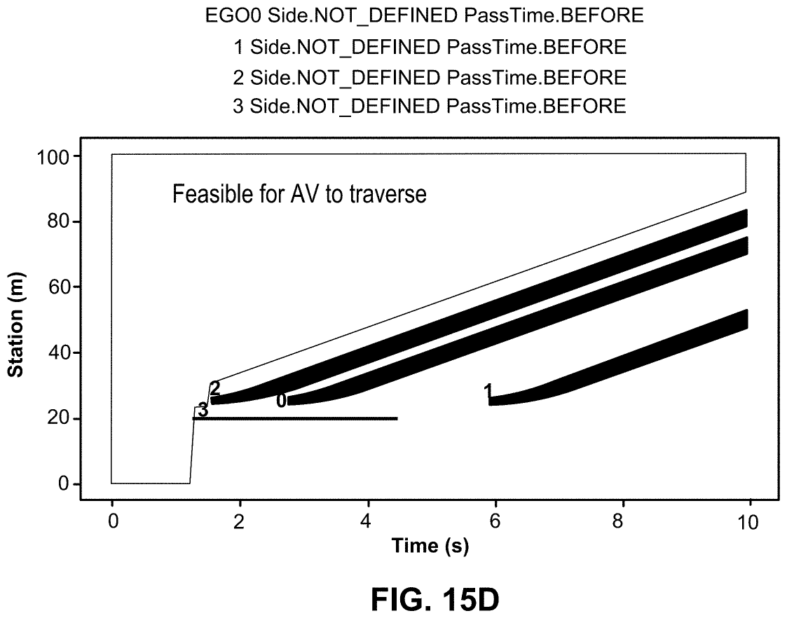

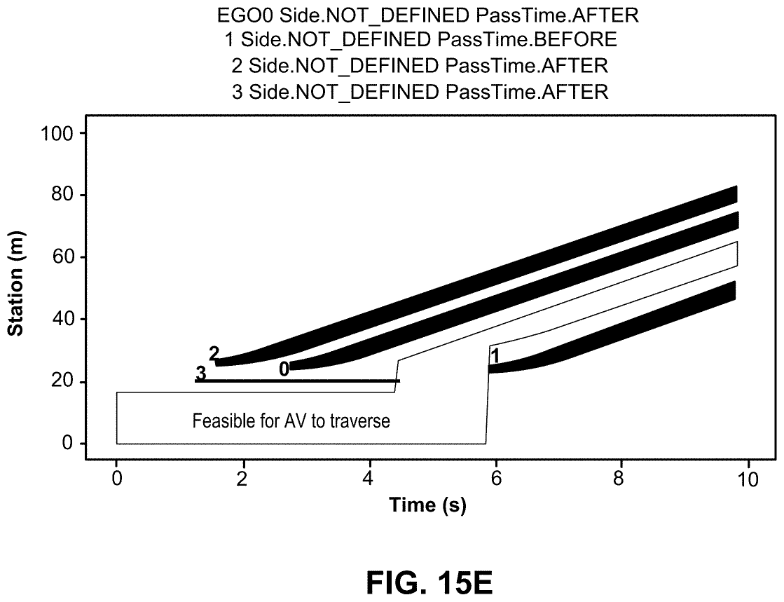

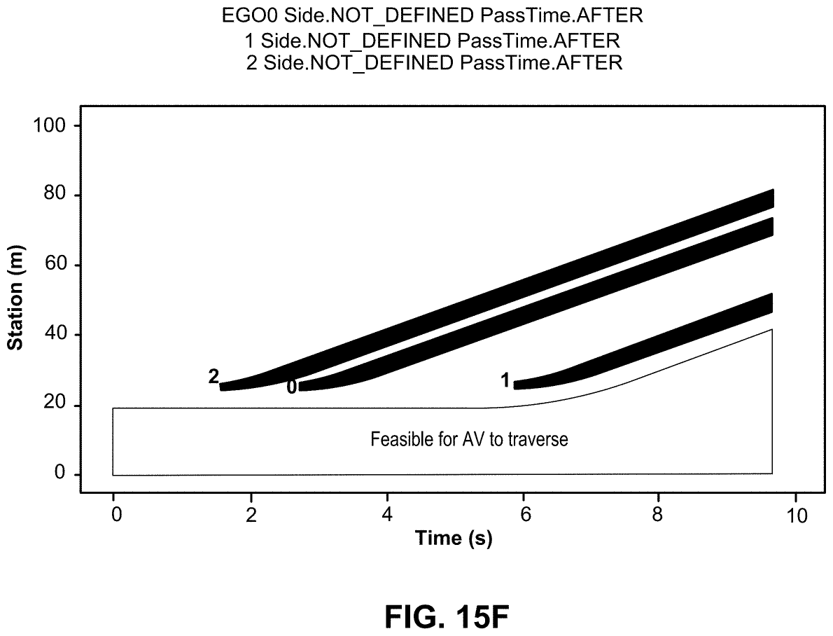

A practical example of assessing the feasibility of homotopies using a decision graph is shown in FIGS. 15A-15F.

In this example (e.g., as shown in FIG. 15A), an AV 100 is positioned on a first road 1510a, and facing an intersection between the first road 1510a and a second road 1510b perpendicular to the first road 1510a. Three vehicles 1512a-1512c proceeding along the second road 1510b, and a pedestrian 1514 is proceeding along a sidewalk 1516 parallel to the second road 1510b. The motion of the vehicles 1512a-1512c and the pedestrian 1514 relative to the AV 100 are represented in the plot 1502 shown in FIG. 15B. For example, Track 0 represents the position of the first vehicle 1512a over time, Track 1 presents the position of the second vehicle 1512b over time, Track 2 represents the position of the third vehicle 1512c over time, and Track 3 represents the position of the pedestrian 1514 over time.

In this traffic scenario, the homotopy extractor 453 determines whether it is feasible for the AV 100 to turn onto the second road 1510b: (i) in front of all three of the vehicles 1512a-1512c; (ii) between the second vehicle 1512b and the first vehicle 1512a; (iii) between the first vehicle 1512a and the third vehicle 1512c; and (iv) after all three of the vehicles 1512a-1512c. As shown in FIG. 15C, the possibilities can be represented in the form of a decision graph 1504 having a number of nodes 1506, each representing a different set of constraints (e.g., whether to turn onto the road in front of the vehicles 1512a-1512c or to wait for the vehicles 1512a-1512c to pass, and one or more “required” constraints, such as those related to safety, legal constraints, performance capabilities, map constraints, etc.). As an example a “required constraint” can be a requirement that the AV 100 not contact any of the vehicles 1512a-1512c or the pedestrian 1514, while obeying traffic laws, while remaining on the road, and while maintaining the safety and comfort of its passengers.

As described above, the homotopy extractor 453 can assess the feasibility of each of the nodes, beginning from the highest level node, and progressing through the nodes of successively lower levels. Based on the position and motion of the vehicles 1512a-1512c and the pedestrian 1514, the homotopy extractor 453 determines that the AV 100 can feasibly turn onto the second road 1510b: (i) in front of all three of the vehicles 1512a-1512c (e.g., as shown in FIG. 15D), corresponding to the node 1506a; (ii) between the second vehicle 1512b the first vehicle 1512a (e.g., as shown in FIG. 15E), corresponding to the node 1506b; and (iii) after all three vehicles 1512a-1512c (e.g., as shown in FIG. 15F), corresponding to the node 1506c. However, the homotopy extractor 453 determines that the AV 100 cannot feasibly turn onto the second road 1510b between the between the first vehicle 1512a and the third vehicle 1512c, due to the pedestrian 1514 entering the path of the AV 100 during that time.

Based on the determination that the AV 100 cannot feasibly turn onto the second road 1510b, the planning module 404 (e.g., using the realization sample-based maneuver realizer 454) can generate one or more candidate trajectories corresponding to each of the nodes 1506a-1506c (while refraining from generating trajectories for the other nodes), and select one of the generated trajectories for execution by a control circuit of the AV 100 (e.g., the controller 1102 shown in FIGS. 11 and 12). In some implementations, one of the generated trajectories can be selected based on the quality score of metrics for each of the trajectories. As described above, the homotopy extractor 453 can determine a feasibility for each of the nodes according to a first degree of precision, and the realization sample-based maneuver realizer 454 can generate candidate trajectories according to second higher degree of precision. Accordingly, the planning module 404 need not generate higher-precision trajectories corresponding to operations or tasks that are not feasible for the AV to perform, and can instead concentrate its processing resources on generating higher-precision trajectories corresponding to operations or tasks that are feasible for the AV to perform. Thus, the planning module 404 can select a trajectory for the AV more quickly and efficiently.

### Example Processes

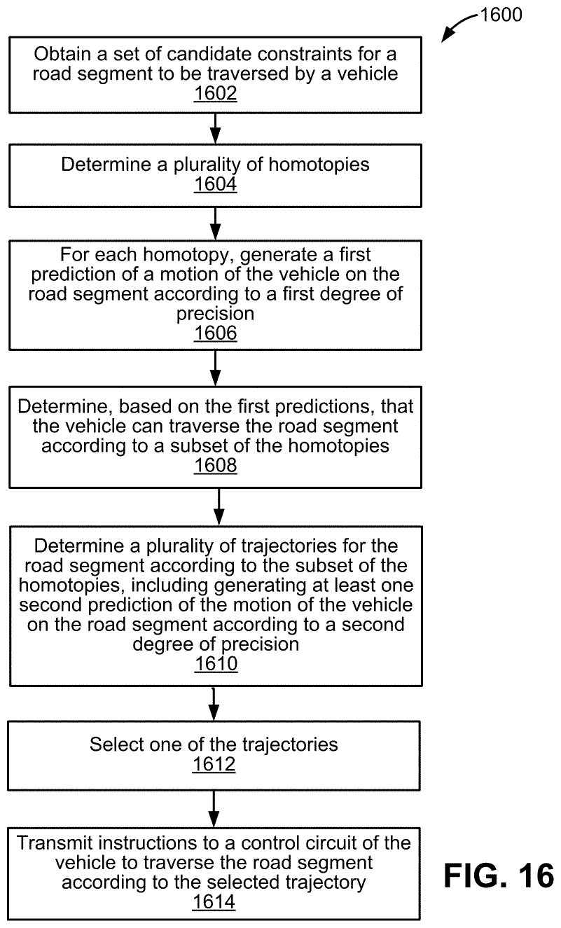

FIG. 16 shows an example process 1600 for controlling an operation of an AV. The process 1600 can be performed, at least in part, using one or more of the systems shown in FIGS. 1-12 (e.g., in accordance with the techniques described with respect to FIGS. 13, 14, and 15A-15E). As an example, the process 1600 can be performed, at least in part, using a planning module 404 including a homotopy extractor 453, a realization sample-based maneuver realizer 454, a trajectory score generator 455, and/or a tracking controller 456 (e.g., as shown in FIGS. 4A, 4B, and 13) using one or more processors.

According to the process 1600, one or more processors obtain a set of candidate constraints for a road segment to be traversed by a vehicle (block 1602).

In some implementations, the candidate constraints can include a speed limit associated with at least a portion of the road segment and/or physical boundaries associated with at least a portion of the road segment.

In some implementations, the candidate constraints can include an acceleration limit associated with the vehicle, a speed limit associated with the vehicle, and/or a braking limit associated with the vehicle.

In some implementations, the candidate constraints can include an indication of at least one moving object along the road segment. Further, the candidate constraints can include, for each of the moving objects, an indication to position the vehicle at a particular location relative to the moving object. At least some of the moving objects can be vehicles. At least some of the moving objects can be pedestrians.

In some implementations, the candidate constraints can include an indication to perform a maneuver using the vehicle, such as perform a lane change while traversing the road segment, making a turn, accelerating, decelerating, or any other maneuver.

The one or more processors determine a plurality of homotopies (block 1604). Each of the homotopies includes a different respective combination of the candidate constraints for traversing the road segment.

For each homotopy, the one or more processors generate a first prediction of a motion of the vehicle on the road segment according to a first degree of precision (block 1606).

Based on the first predictions, the one or more processors determine that the vehicle can traverse the road segment according to a subset of the homotopies (block 1608). Determining that the vehicle can traverse the road segment according to a subset of the homotopies can include determining, based on the first predictions, that the vehicle can traverse the road segment according to the subset of homotopies without colliding with an object.

The one or more processors determine a plurality of trajectories for the road segment according to the subset of the homotopies (block 1610). Determining the plurality of trajectories includes generating at least one second prediction of the motion of the vehicle on the road segment according to a second degree of precision. The second degree of precision is greater than the first degree of precision.

The one or more processors select one of the trajectories (block 1612). In some implementations, selecting one of the trajectories can include determining, for each of the trajectories, a quality metric for that trajectory, and selecting one of the trajectories based on the quality metrics. In some implementations, at least some of the quality metrics can be determined based on a predicted time for traversing the road segment according to the corresponding trajectory, a predicted safety of a passenger of the autonomous vehicle while traversing the road segment according to the corresponding trajectory, and/or a predicted comfort of the passenger of the vehicle while traversing the road segment according to the corresponding trajectory.

In some implementations, a first trajectory of the plurality of trajectories can include an emergency maneuver of the vehicle. Further, selecting one of the trajectories can include receiving data including an indication of a predicted collision between the vehicle and an object, and an indication of the emergency maneuver to avoid the predicted collision. In response to receiving the data, the first trajectory can be selected.

The one or more processors transmit instructions to a control circuit of the vehicle to traverse the road segment according to the selected trajectory (1614). As an example, instructions can be transmitted to a control module 406 (e.g., as shown in FIG. 4A) and/or a controller 1102 (e.g., as shown in FIG. 11).

In some implementations, determining that the vehicle can traverse the road segment according to the subset of the homotopies can include generating a decision graph based on the homotopies. The graph can include a plurality of nodes. Each node can correspond to a different type of action to be performed by the vehicle while traversing the road segment. Example decision graphs are shown in FIGS. 14 and 15C.

Further, determining that the vehicle can traverse road segment according to the subset of the homotopies can include (i) determining, for a first subset of the nodes, whether the vehicle can safely perform the respective type of action, and (ii) refraining from determining, for a second subset of the nodes, whether the vehicle can safely perform the respective type of action.

In some implementations, at least some of the nodes can correspond to performing a lane change while traversing the road segment. In some implementations, at least some of the nodes can correspond to positioning the vehicle ahead of a moving object while traversing the road segment. In some implementations, at least some of the nodes can correspond to positioning the vehicle behind of a moving object while traversing the road segment. In some implementations, at least some of the nodes can correspond to positioning the vehicle between two moving objects while traversing the road segment. In some implementations, at least some of the nodes can correspond to changing a speed of the vehicle while traversing the road segment.

In some implementations, the plurality of trajectories can be determined based on the decision graph.

In the foregoing description, several embodiments have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

### ADDITIONAL EXAMPLES

Example implementations of the features described herein are provided below

Example 1: A method including: obtaining, using at least one processor, a set of candidate constraints for a road segment to be traversed by a vehicle; determining, using the at least one processor, a plurality of homotopies, where each of the homotopies includes a different respective combination of the candidate constraints for traversing the road segment; for each homotopy, generating, using the at least one processor, a first prediction of a motion of the vehicle on the road segment according to a first degree of precision; determining, using the at least one processor and based on the first predictions, that the vehicle can traverse the road segment according to a subset of the homotopies; determining, using the at least one processor, a plurality of trajectories for the road segment according to the subset of the homotopies, where determining the plurality of trajectories includes generating at least one second prediction of the motion of the vehicle on the road segment according to a second degree of precision, the second degree of precision being greater than the first degree of precision; selecting, using the at least one processor, one of the trajectories; and transmitting, using the at least one processor, instructions to a control circuit of the vehicle to traverse the road segment according to the selected trajectory.

Example 2: The method of Example 1, where determining that the vehicle can traverse the road segment according to the subset of the homotopies includes determining, based on the first predictions, that the vehicle can traverse the road segment according to the subset of homotopies without colliding with an object.

Example 3: The method of any one of the preceding Examples, where the candidate constraints includes at least one of: a speed limit associated with at least a portion of the road segment, or physical boundaries associated with at least a portion of the road segment.

Example 4: The method of any one of the preceding Examples, where the candidate constraints includes at least one of: an acceleration limit associated with the vehicle, a speed limit associated with the vehicle, or a braking limit associated with the vehicle.

Example 5: The method of any one of the preceding Examples, where the candidate constraints includes an indication of at least one moving object along the road segment.

Example 6: The method of any one of the preceding Examples, where the candidate constraints include, for each of the at least one moving object, an indication to position the vehicle at a particular location relative to the moving object.

Example 7: The method of any one of the preceding Examples, where the at least one moving object includes at one least of: a vehicle, or a pedestrian.

Examples 8: The method of any one of the preceding Examples, where the candidate constraints include an indication to perform a lane change while traversing the road segment.

Example 9: The method of any one of the preceding Examples, where selecting one of the trajectories includes: determining, for each of the trajectories, a quality metric for that trajectory, and selecting one of the trajectories based on the quality metrics.

Example 10: The method of any one of the preceding Examples, where each of the quality metrics is determined based on at least one of: a predicted time for traversing the road segment according to the corresponding trajectory, a predicted safety of a passenger of the autonomous vehicle while traversing the road segment according to the corresponding trajectory, or a predicted comfort of the passenger of the vehicle while traversing the road segment according to the corresponding trajectory.

Example 11: The method of any one of the preceding Examples, where a first trajectory of the plurality of trajectories includes an emergency maneuver of the vehicle.

Example 12: The method of any one of the preceding Examples, where the selecting one of the trajectories includes: receiving, using the at least one processor, data including: an indication of a predicted collision between the vehicle and an object, and an indication of the emergency maneuver to avoid the predicted collision, and in response to receiving the data, selecting the first trajectory.

Example 13: The method of any one of the preceding Examples, where determining that the vehicle can traverse the road segment according to the subset of the homotopies includes generating a decision graph based on the homotopies, where the graph includes a plurality of nodes, and where each node corresponds to a different type of action to be performed by the vehicle while traversing the road segment.

Example 14: The method of any one of the preceding Examples, where determining that the vehicle can traverse road segment according to the subset of the homotopies includes: determining, for a first subset of the nodes, whether the vehicle can safely perform the respective type of action, and refraining from determining, for a second subset of the nodes, whether the vehicle can safely perform the respective type of action.

Example 15: The method of any one of the preceding Examples, where at least one of the nodes corresponds to performing a lane change while traversing the road segment.

Example 16: The method of any one of the preceding Examples, where at least one of the nodes corresponds to positioning the vehicle ahead of a moving object while traversing the road segment.

Example 17: The method of any one of the preceding Examples, where at least one of the nodes corresponds to positioning the vehicle behind of a moving object while traversing the road segment.

Example 18: The method of any one of the preceding Examples, where at least one of the nodes corresponds to positioning the vehicle between two moving objects while traversing the road segment.

Example 19: The method of any one of the preceding Examples, where at least one of the nodes corresponds to changing a speed of the vehicle while traversing the road segment.

Example 20: The method of any one of the preceding Examples, where the plurality of trajectories are determined based on the decision graph.

Example 21: An autonomous vehicle including: one or more computer processors; and one or more non-transitory storage media storing instructions which, when executed by the one or more computer processors, cause performance of the method of any one of Examples 1-20.

Example 22: One or more non-transitory storage media storing instructions which, when executed by one or more computing devices, cause performance of the method of any one of Examples 1-20.

What is claimed is:

1. A method comprising:
obtaining, using at least one processor, a set of candidate constraints for a road segment to be traversed by a vehicle;
determining, using the at least one processor, a plurality of homotopies, wherein each of the homotopies comprises a different respective combination of the candidate constraints for traversing the road segment;
for each homotopy:
generating, using the at least one processor, a first prediction of a motion of the vehicle on the road segment according to a first degree of precision;
determining, using the at least one processor and based on the first predictions, that the vehicle can traverse the road segment according to a subset of the homotopies;
determining, using the at least one processor, a plurality of trajectories for the road segment according to the subset of the homotopies, wherein determining the plurality of trajectories comprises:
generating at least one second prediction of the motion of the vehicle on the road segment according to a second degree of precision, the second degree of precision being greater than the first degree of precision;
selecting, using the at least one processor, one of the trajectories; and
transmitting, using the at least one processor, instructions to a control circuit of the vehicle to traverse the road segment according to the selected trajectory.

2. The method of claim 1, wherein determining that the vehicle can traverse the road segment according to the subset of the homotopies comprises:
determining, based on the first predictions, that the vehicle can traverse the road segment according to the subset of homotopies without colliding with an object.

3. The method of claim 1, wherein the candidate constraints comprises at least one of:
a speed limit associated with at least a portion of the road segment, or
physical boundaries associated with at least a portion of the road segment.

4. The method of claim 1, wherein the candidate constraints comprises at least one of:
an acceleration limit associated with the vehicle,
a speed limit associated with the vehicle, or
a braking limit associated with the vehicle.

5. The method of claim 1, wherein the candidate constraints comprises an indication of at least one moving object along the road segment.

6. The method of claim 5, wherein the candidate constraints comprises, for each of the at least one moving object, an indication to position the vehicle at a particular location relative to the moving object.

7. The method of claim 5, wherein the at least one moving object comprises at one least of:
a vehicle, or
a pedestrian.

8. The method of claim 1, wherein the candidate constraints comprises an indication to perform a lane change while traversing the road segment.

9. The method of claim 1, wherein selecting one of the trajectories comprises:
determining, for each of the trajectories, a quality metric for that trajectory, and
selecting one of the trajectories based on the quality metrics.

10. The method of claim 9, wherein each of the quality metrics is determined based on at least one of:
a predicted time for traversing the road segment according to the corresponding trajectory,
a predicted safety of a passenger of the autonomous vehicle while traversing the road segment according to the corresponding trajectory, or
a predicted comfort of the passenger of the vehicle while traversing the road segment according to the corresponding trajectory.

11. The method of claim 1, wherein a first trajectory of the plurality of trajectories comprises an emergency maneuver of the vehicle.

12. The method of claim 11, wherein the selecting one of the trajectories comprises:
receiving, using the at least one processor, data comprising:
an indication of a predicted collision between the vehicle and an object, and
an indication of the emergency maneuver to avoid the predicted collision, and
in response to receiving the data, selecting the first trajectory.

13. The method of claim 1, wherein determining that the vehicle can traverse the road segment according to the subset of the homotopies comprises:
generating a decision graph based on the homotopies, wherein the graph comprises a plurality of nodes, and wherein each node corresponds to a different type of action to be performed by the vehicle while traversing the road segment.

14. The method of claim 13, wherein determining that the vehicle can traverse road segment according to the subset of the homotopies comprises:
determining, for a first subset of the nodes, whether the vehicle can safely perform the respective type of action, and
refraining from determining, for a second subset of the nodes, whether the vehicle can safely perform the respective type of action.

15. The method of claim 13, wherein at least one of the nodes corresponds to performing a lane change while traversing the road segment.

16. The method of claim 13, wherein at least one of the nodes corresponds to positioning the vehicle ahead of a moving object while traversing the road segment.

17. The method of claim 13, wherein at least one of the nodes corresponds to positioning the vehicle behind of a moving object while traversing the road segment.

18. The method of claim 13, wherein at least one of the nodes corresponds to positioning the vehicle between two moving objects while traversing the road segment.

19. The method of claim 13, wherein at least one of the nodes corresponds to changing a speed of the vehicle while traversing the road segment.

20. The method of claim 13, wherein the plurality of trajectories are determined based on the decision graph.

21. An autonomous vehicle comprising:
one or more computer processors;
one or more non-transitory storage media storing instructions which, when executed by the one or more computer processors, cause performance of the method of claim 1.

22. One or more non-transitory storage media storing instructions which, when executed by one or more computing devices, cause performance of the method recited in claim 1.
